(19) United States
(12) Patent Application Publication
(10) Pub. No.: US 2015/0066752 A1
(43) Pub. Date: Mar. 5, 2015

(54) SYSTEMS, METHODS, AND COMPUTER PROGRAM PRODUCTS FOR PROVIDING INTEGRATED MANAGEMENT OF RETURNS INITIATED OVER A NETWORK

(71) Applicant: UNITED PARCEL SERVICE OF AMERICA, INC., Atlanta, GA (US)

(72) Inventor: Jeffery Steven Phillips, Buford, GA (US)

(73) Assignee: UNITED PARCEL SERVICE OF AMERICA, INC., Atlanta, GA (US)

(21) Appl. No.: 14/015,152

(22) Filed: Aug. 30, 2013

(51) Int. Cl. G06Q 10/08; G06Q 20/10

(52) U.S. Cl. CPC G06Q 10/0837; G06Q 20/102
USPC 705/40

(57) ABSTRACT

Various embodiments provide an online returns management system for facilitating a carrier acquiring a credit amount due for transporting to a supplier one or more items. The system comprises one or more computer processors configured to: assign a tracking identifier to at least one return request, the tracking identifier being associated further with existing order data and being configured for tracking shipment of the one or more items; generate an electronic shipping label configured for use by at least one carrier to facilitate transport of the one or more items to the supplier. The computer processors are further configured to determine a transit status for the one or more items based upon received tracking data; and in response to delivery of the one or more items, generate one or more notifications of a credit amount due the carrier. Associated methods and computer program products are also provided.

### BACKGROUND

Traditional returns transactions involve one or more customers contacting one or more suppliers or merchants (collectively “suppliers”), via email, phone, or otherwise, to inform the one or more suppliers that the one or more customers intend to return an item previously purchased from the one or more suppliers. As a non-limiting example, after approving the return, a supplier obtains a physical return shipping label from a common carrier (e.g., “carrier”), such as the United Parcel Service (UPS), and mails the return shipping label to a customer, along with any special instructions on how to package the item(s) to be returned. Next, the customer repackages the item(s) as instructed, affixes the physical return shipping label to the package, and drops the package off with the carrier, who in turn delivers it to the supplier.

This return process is both time consuming and highly manual. It usually takes a week or more for the supplier to obtain a return shipping label from a carrier and to have the label mailed to the customer. In addition, the supplier must have customer service representatives available to receive and approve the customer return request and to initiate the request to the carrier to have a return shipping label printed and provided. If the label is lost or destroyed in the mailing process, additional delays and expense can result as the customer contacts the supplier and has to re-initiate the entire returns process.

To address certain of the above-described problems, systems and methods for initiating returns over a network have been developed. For example, as described in U.S. Pat. Nos. 7,430,527 & 8,417,574, an online return application may be configured to generate an electronic return shipping label that can be delivered to a customer wishing to make a return. The customer may then generate or print the physical return shipping label for affixation thereof to a package containing one or more item(s) identified for return. While such systems and methods address certain inefficiencies as have existed within traditional returns transactions as between customers and suppliers, inefficiencies remain as between carriers and suppliers.

As a non-limiting example, a common challenge faced by transit companies (e.g., “carriers”) that handle customer initiated returns of goods to a retailer or supplier thereof is that the responsibility for crediting the carriers for any costs and/or fees incurred for transport of the goods returns rests with the retailer and/or supplier entity. Oftentimes, however, retailer and/or supplier entities fail to reimburse or credit the carriers for their incurred costs and/or fees. Amongst various ramifications, delayed or non-occurring credits create significant financial and administrative burdens for the carriers seeking to obtain proper credits due. Analogous burdens exist for suppliers, who must not only coordinate and handle invoicing of carriers for forward-cycle deliveries (e.g., to customers) of packages and/or items, but also coordinate and handle timely and efficient crediting and/or debiting of accounts where reverse-cycle returns are later initiated by the customer.

Needs therefore exist for systems and methods that provide carriers with an integrated tool to manage processing of returns initiated over a network, including the processing of appropriate credits due therefor in an accurate and timely fashion.

### BRIEF SUMMARY

According to various embodiments of the present invention, a computer-implemented method for facilitating a carrier acquiring a credit amount due for transporting to a supplier one or more items that were previously purchased from the supplier is provided. The method comprises the steps of: receiving and storing within one or more memory storage areas request data associated with at least one return request initiated by at least one customer for the transport of the one or more items being returned to the supplier; assigning, via one or more computer processors, a tracking identifier to the at least one return request, the tracking identifier being configured for tracking shipment of the one or more items during transport to the supplier; generating, via the one or more computer processors, an electronic shipping label, the electronic shipping label comprising a representation of at least the tracking identifier and being configured for use by at least one carrier to facilitate transport of the one or more items to the supplier; receiving tracking data associated with transport of the one or more items being returned to the supplier, the tracking data being associated with the tracking identifier assigned to the at least one return request; determining, via the one or more computer processors, a transit status for the one or more items, the transit status being determined based at least in part upon the received tracking data; and in response to the transit status indicating delivery of the one or more items to the supplier is completed, generating, via the one or more computer processors, one or more notifications of a credit amount due the carrier, the one or more notifications being configured to facilitate the carrier obtaining the credit amount due from the supplier.

According to various embodiments, an online returns management system for facilitating a carrier acquiring a credit amount due for transporting to a supplier one or more items that were previously purchased from the supplier is provided. The system comprises: one or more memory storage areas containing existing order data associated with the one or more items; and one or more computer processors. The one or more computer processors are configured to: receive request data associated with at least one return request initiated by at least one customer for the transport of the one or more items being returned to the supplier; assign a tracking identifier to the at least one return request, the tracking identifier being associated further with the existing order data and being configured for tracking shipment of the one or more items during transport to the supplier; generate an electronic shipping label, the electronic shipping label comprising a representation of at least the tracking identifier and being configured for use by at least one carrier to facilitate transport of the one or more items to the supplier; receive tracking data associated with transport of the one or more items being returned to the supplier, the tracking data being associated with the tracking identifier assigned to the at least one return request; determine a transit status for the one or more items, the transit status being determined based at least in part upon the received tracking data; and in response to the transit status indicating delivery of the one or more items to the supplier is completed, generate one or more notifications of a credit amount due the carrier, the one or more notifications being configured to facilitate the carrier obtaining the credit amount due from the supplier.

According to various embodiments, a non-transitory computer program product comprising at least one computer-readable storage medium having computer-readable program code portions embodied therein is provided. The computer-readable program code portions comprise: an executable portion configured for assigning a tracking identifier to the at least one return request, the tracking identifier being configured for tracking shipment of the one or more items during transport to the supplier; an executable portion configured for receiving a plurality of data, wherein the data comprises: (i) existing order data associated with the one or more items; (ii) request data associated with at least one return request initiated by at least one customer for the transport of the one or more items being returned to the supplier; and (iii) tracking data associated with transport of the one or more items being returned to the supplier, the tracking data being associated with the tracking identifier assigned to the at least one return request. The computer-readable program code portions further comprise: an executable portion configured for generating an electronic shipping label, the electronic shipping label comprising a representation of at least the tracking identifier and being configured for use by at least one carrier to facilitate transport of the one or more items to the supplier; and an executable portion configured for: determining a transit status for the one or more items, the transit status being determined based at least in part upon the received tracking data; and in response to the transit status indicating delivery of the one or more items to the supplier is completed, generating one or more notifications of a credit amount due the carrier, the one or more notifications being configured to facilitate the carrier obtaining the credit amount due from the supplier.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 is a block diagram of an online returns management system 20 according to various embodiments;

FIG. 2A is schematic block diagram of a carrier returns crediting server 200 according to various embodiments;

FIG. 2A is schematic block diagram of an exemplary mobile device 300 according to various embodiments;

FIG. 3 illustrates an overall process flow for various modules of the carrier server 200 according to various embodiments;

FIG. 4 illustrates a schematic diagram of various databases that are utilized by the online returns management system 20 shown in FIG. 1 according to various embodiments;

FIG. 5 is a schematic block diagram of a data module 400, a returns module 500, a crediting module 600, and a notification module 700, all as also illustrated in FIGS. 2A and 3 according to various embodiments;

FIG. 6 illustrates an exemplary process flow according to various embodiments for the data module 400 shown in FIGS. 2A and 5;

FIG. 7 illustrates an exemplary process flow according to various embodiments for the returns module 500 shown in FIGS. 2A and 5;

FIG. 8 illustrates an exemplary process flow according to various embodiments for the crediting module 600 shown in FIGS. 2A and 5;

FIG. 9 illustrates an exemplary process flow according to various embodiments for the notification module 700 shown in FIGS. 2A and 5;

FIG. 10 illustrates an exemplary integrated user interface process flow according to various embodiments of the online returns management system 20 of FIG. 1;

FIG. 11 illustrates exemplary customer login fields for a user interface according to various embodiments of the online returns management system 20 of FIG. 1;

FIG. 12 illustrates an exemplary return request screen 1000 of the user interface of FIG. 11 according to various embodiments of the online returns management system 20 of FIG. 1;

FIG. 13 illustrates an exemplary return confirmation screen 1100 of the user interface of FIG. 11 according to various embodiments of the returns crediting system 20 of FIG. 1;

FIG. 14 illustrates an exemplary electronic shipping label link 1200 of the user interface of FIG. 11 according to various embodiments of the returns crediting system 20 of FIG. 1;

FIG. 15 illustrates an exemplary electronic shipping label link 1300 of the user interface of FIG. 11 according to various embodiments of the returns crediting system 20 of FIG. 1; and

FIG. 16 illustrates an exemplary Debit Memo (Credit) 1400 according to various embodiments of the online returns management system 20 of FIG. 1.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Exemplary Apparatuses, Methods, Systems, Computer Program Products, & Computing Entities

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

Exemplary Architecture of Online Returns Management System 20

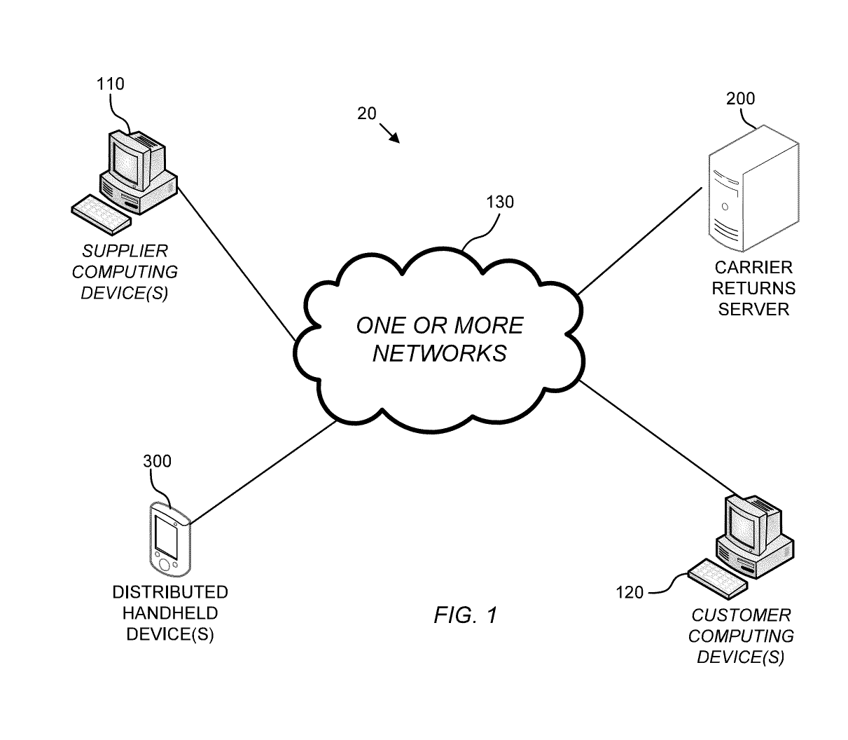

FIG. 1 is a block diagram of an online returns management system 20 that can be used in conjunction with various embodiments of the present invention. In at least the illustrated embodiment, the system 20 may include one or more supplier computing devices 110, one or more customer computing devices 120, and one or more distributed handheld or mobile devices 300, each configured in communication with a carrier returns server 200 via one or more networks 130. While FIG. 1 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 5 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the supplier computing device(s) 110, the distributed handheld or mobile device(s) 300, the customer computing device(s) 120, and the carrier returns server 200 are illustrated in FIG. 1 as communicating with one another over the same network 130, these devices may likewise communicate over multiple, separate networks. For example, while the customer computing devices 120 may communicate with the server 200 over a wireless personal area network (WPAN) using, for example, Bluetooth techniques, one or more of the remaining distributed devices 300, 110 may communicate with the server 200 over a wireless wide area network (WWAN), for example, in accordance with EDGE, or some other 2.5G wireless communication protocol.

According to one embodiment, in addition to receiving data from the carrier returns server 200, the distributed devices 110, 120, and/or 300 may be further configured to collect and transmit data on their own. Indeed, in certain embodiments at least one of the distributed handheld devices 300 may be any device associated with a carrier (e.g., a common carrier, such as UPS, FedEx, USPS, etc.). In at least one embodiment, the device 300 may comprise a DIAD, as such is commonly known and understood to be used by at least UPS. In these and other embodiments, others or all of the distributed handheld devices 300 may be devices alternatively associated with any of the supplier, customer, or carrier, in addition to or as alternatives to the supplier and/or customer computing devices 110, 120. Regardless, in various embodiments, the devices 110, 120, 300 may be capable of receiving data via one or more input units or devices, such as a keypad, touchpad, barcode scanner, radio frequency identification (RFID) reader, interface card (e.g., modem, etc.) or receiver. The devices 110, 120, and 300 may further be capable of storing data to one or more volatile or non-volatile memory modules, and outputting the data via one or more output units or devices, for example, by displaying data to the user operating the device, or by transmitting data, for example over the one or more networks 130. One type of a distributed handheld device 110, which may be used in conjunction with embodiments of the present invention is the Delivery Information Acquisition Device (DIAD) presently utilized by UPS.

Exemplary Carrier Returns Server 200

In various embodiments, the carrier returns server 200 includes various systems for performing one or more functions in accordance with various embodiments of the present invention, including those more particularly shown and described herein. It should be understood, however, that the server 200 might include a variety of alternative devices for performing one or more like functions, without departing from the spirit and scope of the present invention. For example, at least a portion of the server 200, in certain embodiments, may be located on the distributed computing device(s) 110, 120 and/or the distributed handheld or mobile device(s) 300, as may be desirable for particular applications. As will be described in further detail below, in at least one embodiment, the handheld or mobile device(s) 300 may contain one or more mobile applications 330 which may be configured so as to provide a user interface for communication with the carrier returns server 200, all as will be likewise described in further detail below.

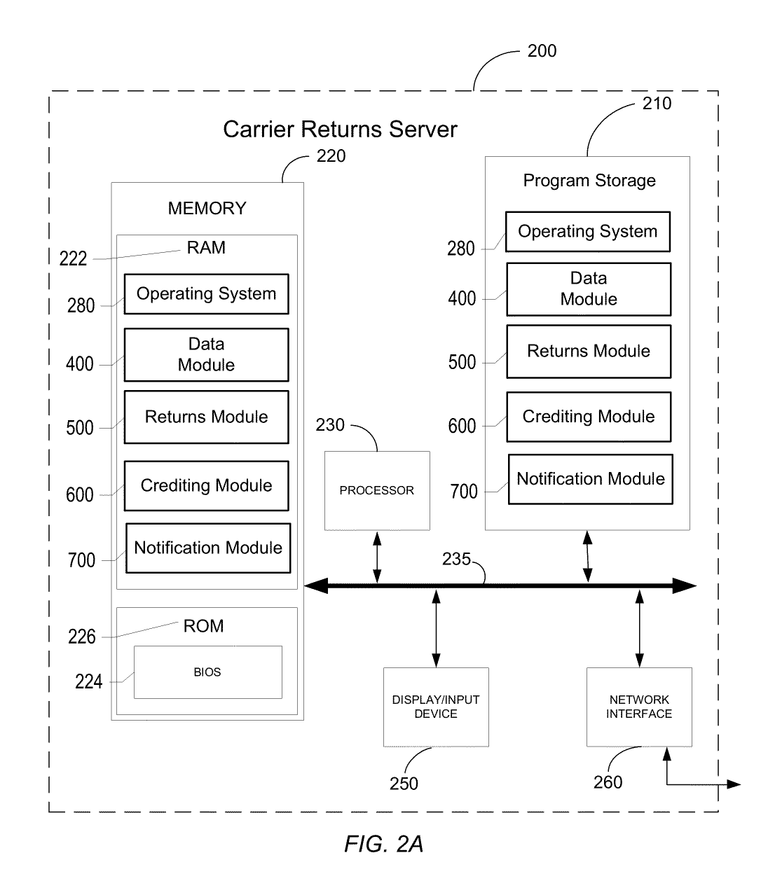

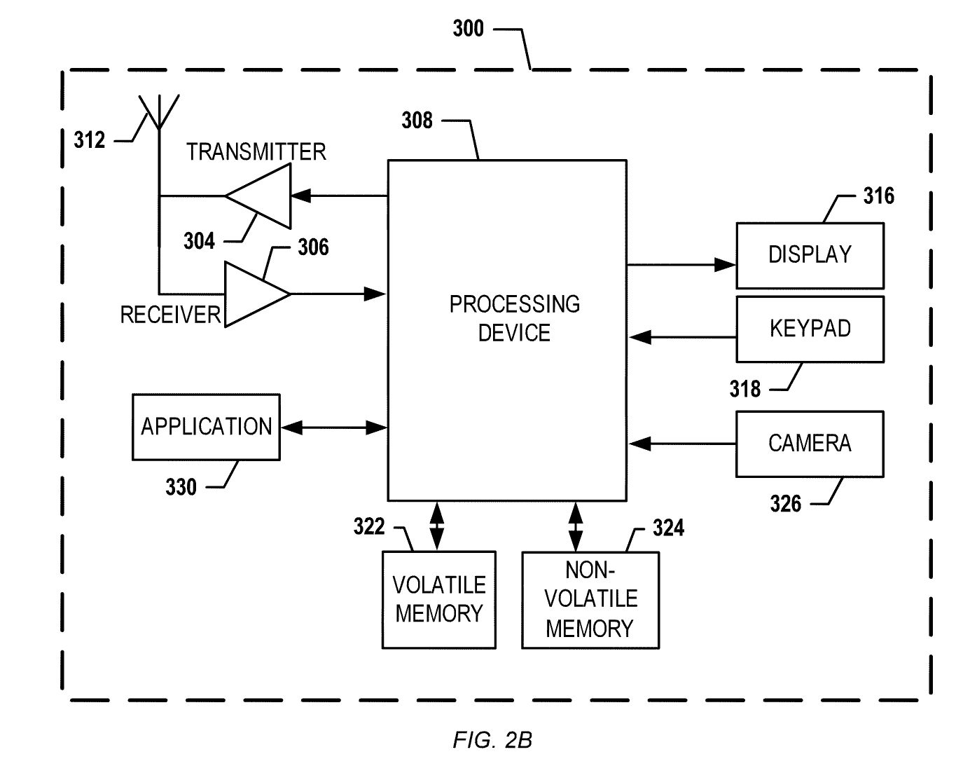

FIG. 2A is a schematic diagram of the carrier returns server 200 according to various embodiments. The server 200 includes a processor 230 that communicates with other elements within the server via a system interface or bus 235. Also included in the server 200 is a display/input device 250 for receiving and displaying data. This display/input device 250 may be, for example, a keyboard or pointing device that is used in combination with a monitor. The server 200 further includes memory 220, which preferably includes both read only memory (ROM) 226 and random access memory (RAM) 222. The server's ROM 226 is used to store a basic input/output system 224 (BIOS), containing the basic routines that help to transfer information between elements within the server 200. Various ROM and RAM configurations have been previously described herein.

In addition, the carrier returns server 200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 210 are connected to the system bus 235 by an appropriate interface. The storage devices 210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 210 and/or memory of the carrier returns server 200 may further provide the functions of a data storage device, which may store historical and/or current delivery data and delivery conditions that may be accessed by the server 200. In this regard, the storage device 210 may comprise one or more databases. The term “database” refers to a structured collection of records or data that is stored in a computer system, such as via a relational database, hierarchical database, or network database and as such, should not be construed in a limiting fashion.

A number of program modules comprising, for example, one or more computer-readable program code portions executable by the processor 230, may be stored by the various storage devices 210 and within RAM 222. Such program modules include an operating system 280, a data module 400, a returns module 500, a crediting module 600, and a notification module 700. In these and other embodiments, the various modules 400, 500, 600, 700 control certain aspects of the operation of the server 200 with the assistance of the processor 230 and operating system 280. In still other embodiments, it should be understood that one or more additional and/or alternative modules may also be provided, without departing from the scope and nature of the present invention.

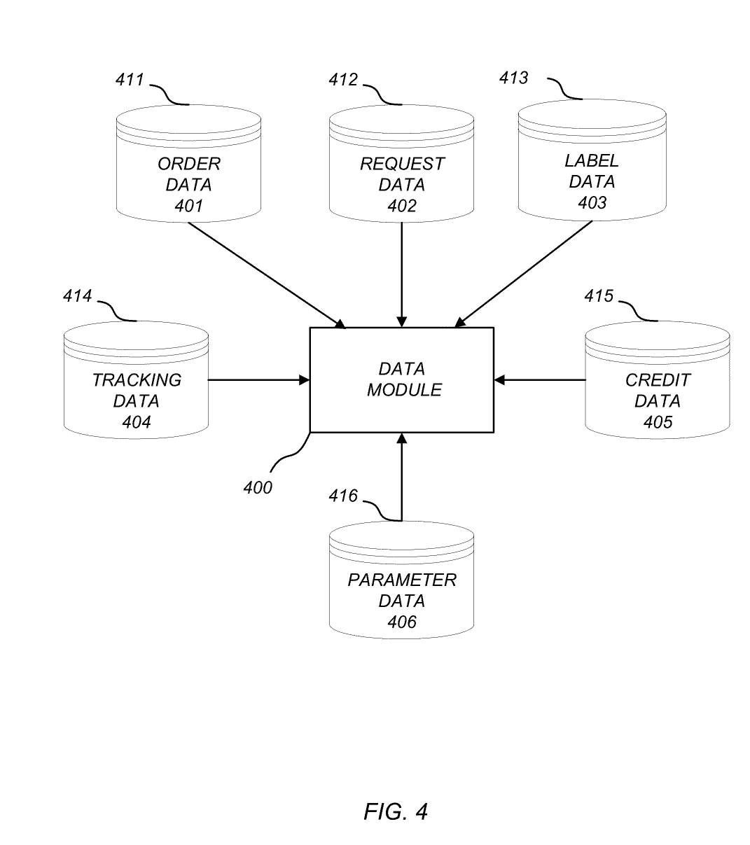

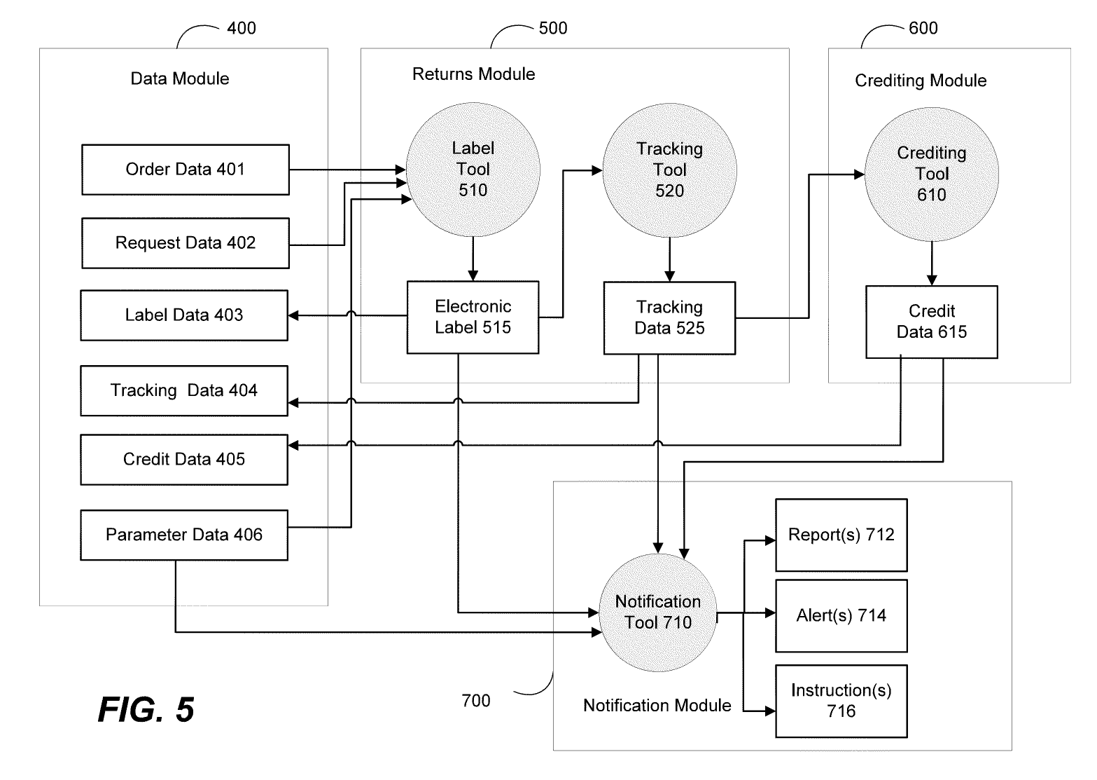

In general, as will be described in further detail below, the data module 400 is configured to receive, store, manage, and transmit a variety of data as may be provided by one or more users of the system 20. Non-limiting examples, as illustrated in FIG. 4, may include order data 401, request data 402, label data 403, tracking data 404, credit data 405, and parameter data 406. With reference momentarily to FIG. 5, according to various embodiments, the data module 400 is configured to provide at least a portion of this data to the returns module 500, whether proactively or upon request therefor. In certain embodiments, at least a portion of this data may be separately and/or alternatively provided to the notification module 700, as will be described in further detail below. In other embodiments, at least a portion of this data may be received from at least one of the returns module 500 and/or the crediting module 600 upon generation and/or receipt thereby, wherein such data is forwarded further to the data module 400 for at least storage and maintenance thereof. Amongst a variety of considerations, the determination of which modules to which the various portions of the data is transmitted depends at least in part upon the context and type of data received.

Remaining with FIG. 5, upon receipt of any portion of data, the returns module 500 may be configured to execute at least a label tool 510 to generate an electronic label 515 and/or label link, as will be described in further detail below. That electronic label 515 may be then transmitted to the notification module 700 for further provision to one or more users of the system 20 and/or to a tracking tool 520, as may be further contained within the returns module 500. The tracking tool 520, as will be detailed further below, may be configured to provide real-time, near-real-time, and/or periodic updates regarding transit of the one or more packages and/or items being returned. The crediting module 600, which is also provided according to various embodiments, is configured to generate various types of credit data 615 based at least in part upon the content of latest receipted tracking data 525, all as will be described in further detail below. Upon generation of any one of the electronic label 515 (or link thereto), tracking data 525, and/or any of the various types of credit data 615, the modules 500, 600 generating such data may be further configured to transmit the same, whether automatically or upon request therefor, to at least the notification module 700. Details of processing of the same via the notification module 700 will be described in further detail below; however, it should be understood that the execution thereof will generally, in certain embodiments, result in the generation and/or transmittal of one or more reports 712, alerts 714, and/or instructions 716 (e.g., memos, source code, and the like) to one or more users of the system 20 or to one or more devices 110, 120, 300, as may be operated by the one or more users of the system.

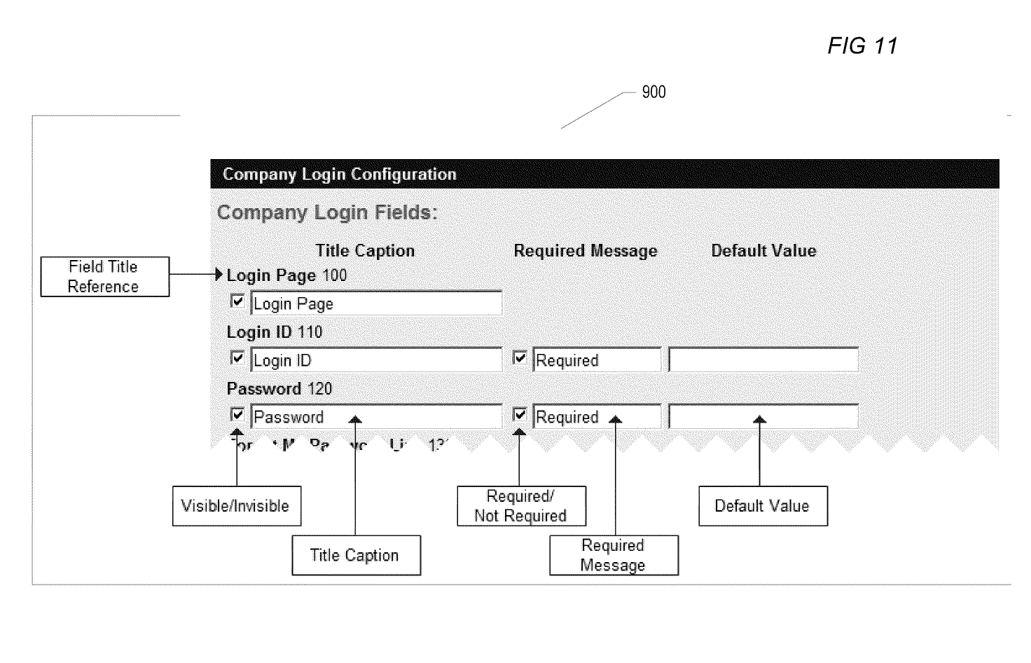

In various embodiments, the program modules 400, 500, 600, 700 are executed by the server 200 and are configured to generate one or more graphical user interfaces, reports, instructions, and/or notifications/alerts, all accessible and/or transmittable to various users of the system 20. In certain embodiments, the user interfaces, reports, instructions, and/or notifications/alerts may be accessible via one or more networks 130, which may include the Internet or other feasible communications network, as previously discussed. Exemplary screen displays of for population of return requests, along with exemplary screen displays of generated reports, instructions, and/or notifications/alerts may be seen in FIGS. 11-16, as will be described in further detail below.

In various embodiments, it should also be understood that one or more of the modules 400, 500, 600, 700 may be alternatively and/or additionally (e.g., in duplicate) stored locally on one or more of the devices 110, 120, and/or 300 and may be executed by one or more processors of the same. According to various embodiments, the modules 400, 500, 600, 700 may send data to, receive data from, and utilize data contained in, one or more databases (see FIG. 4), which may be comprised of one or more separate, linked and/or networked databases.

Also located within the carrier returns server 200 is a network interface 260 for interfacing and communicating with other elements of the one or more networks 130. It will be appreciated by one of ordinary skill in the art that one or more of the server 200 components may be located geographically remotely from other server components. Furthermore, one or more of the server 200 components may be combined, and/or additional components performing functions described herein may also be included in the server.

While the foregoing describes a single processor 230, as one of ordinary skill in the art will recognize, the carrier returns server 200 may comprise multiple processors operating in conjunction with one another to perform the functionality described herein. In addition to the memory 220, the processor 230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

Distributed Handheld (or Mobile) Device(s) 300

FIG. 2B provides an illustrative schematic representative of a mobile device 300 that can be used in conjunction with various embodiments of the present invention. Mobile devices 300 can be operated by various parties, including customers, carriers, suppliers, and the like, along with operators of various devices described previously herein (e.g., supplier and/or customer computing devices 110, 120). As shown in FIG. 2B, a mobile device 300 may include an antenna 312, a transmitter 304 (e.g., radio), a receiver 306 (e.g., radio), and a processing element 308 that provides signals to and receives signals from the transmitter 304 and receiver 306, respectively.

The signals provided to and received from the transmitter 304 and the receiver 306, respectively, may include signaling data in accordance with an air interface standard of applicable wireless systems to communicate with various entities, such as the carrier returns server 200, the distributed devices 110, 120, and/or the like. In this regard, the mobile device 300 may be capable of operating with one or more air interface standards, communication protocols, modulation types, and access types. More particularly, the mobile device 300 may operate in accordance with any of a number of wireless communication standards and protocols. In a particular embodiment, the mobile device 300 may operate in accordance with multiple wireless communication standards and protocols, such as GPRS, UMTS, CDMA2000, 1xRTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 300 can also download changes, add-ons, and updates, for instance, to its firmware, software (e.g., including executable instructions, applications, program modules), and operating system.

According to one embodiment, the mobile device 300 may include a location determining device and/or functionality. For example, the mobile device 300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 300 may also comprise a user interface (that can include a display 316 coupled to a processing element 308) and/or a user input interface (coupled to a processing element 308). The user input interface can comprise any of a number of devices allowing the mobile device 300 to receive data, such as a keypad 318 (hard or soft), a touch display, voice or motion interfaces, or other input device. In embodiments including a keypad 318, the keypad can include (or cause display of) the conventional numeric (0-9) and related keys (#, *), and other keys used for operating the mobile device 300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 300 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 300.

The mobile device 300 may also include one or more of a camera 326 and a mobile application 330. The camera 326 may be configured according to various embodiments as an additional and/or alternative data collection feature, whereby one or more features of a shipping returns label may be read, stored, and/or transmitted by the mobile device 300 via the camera. The mobile application 330 may further provide a feature via which various tasks may be performed with the mobile 300, whether the initiation and/or population of a returns request (as described elsewhere herein) or the real-time or near-real-time tracking of items once delivery for return has commenced. Various configurations may be provided, as may be desirable for one or more users of the mobile device 300 and the system 20 as a whole.

Carrier Returns Server 200 Logic Flow

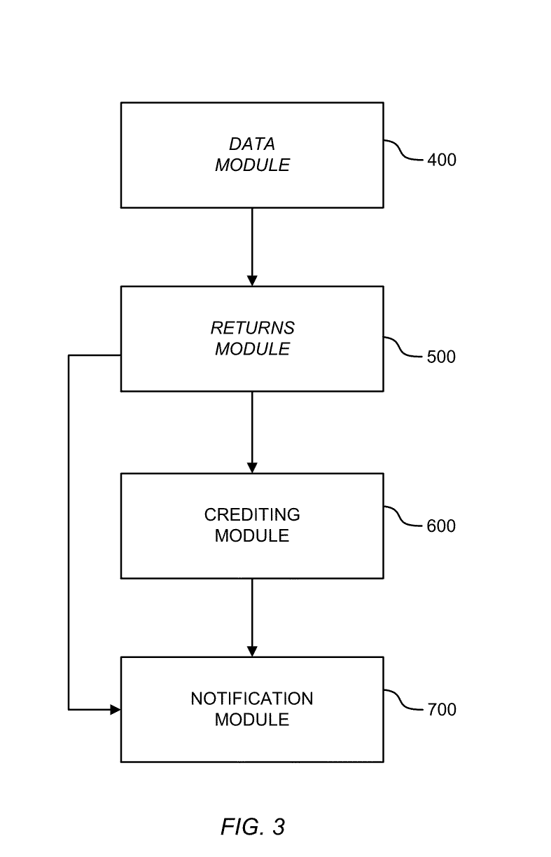

Reference is now made to FIGS. 3-9, which illustrate various logical process flows executed by various embodiments of the modules described above. In particular, FIG. 3 illustrates the overall relationship of the modules 400, 500, 600, 700 of the server 200, according to various embodiments. As illustrated, operation of the system 20 begins, according to various embodiments, with the execution of the data module 400, which is configured to receive, store, manage, and transmit any of a variety of types of data (see FIGS. 4-5). Certain portions of the data are provided, as desirable, to at least the returns module 500 and the notification module 700. As a non-limiting example, when request data 402 indicative of a request from a user to initiate return of one or more item(s) is received, at least that data and some portion of order data 401 and/or parameter data 406 may be transmitted to at least the returns module 500 for further processing and handling thereof. Further details in that regard and still other non-limiting examples will be described in elsewhere herein.

Remaining with FIG. 5 in particular, the returns module 500 may be configured to execute at least a label tool 510 to generate an electronic label 515 and/or label link, as will be described in further detail below. That electronic label 515 (or a link representative thereof) may be then transmitted to the notification module 700 for further provision to one or more users of the system 20 and/or to a tracking tool 520, as may be further contained within the returns module 500. The tracking tool 520, as will be detailed further below, may be configured to provide real-time, near-real-time, and/or periodic updates regarding transit of the one or more packages and/or items being returned. As a non-limiting example, such updates may be based at least upon a unique tracking identifier located on the electronic label 515 and associated with at least the item(s) being returned. Upon generation of at least the electronic label 515 and/or the tracking data 525, such may be transmitted according to various embodiments to one or more of the crediting module 600, the notification module 700, and/or even the data module 400 for further processing.

The crediting module 600, which is also provided according to various embodiments and as illustrated in FIG. 5, is configured to generate various types of credit data 615 based at least in part upon the content of latest receipted tracking data 525, all as will be described in further detail below. As a non-limiting example, the crediting tool 610 of the crediting module 600 (see FIG. 5) may be configured to determine a status of the item being returned; if the received tracking data 525 indicates that the item is “en route” then the crediting tool 610 may be configured to generate credit data 615 comprising an amount of credit to be taken by the carrier. Such credit data 615 may be, in certain embodiments, further transmitted to the notification module 700, which may be configured to, in turn, notify one or more users of the system (e.g., the supplier expecting the return) of the upcoming credit amount. As another non-limiting example, if the tracking data 525 indicates that the item has been “delivered” (e.g., as may be received from a scan of the item via a mobile DIAD device or otherwise), the crediting tool 610 may be configured to facilitating processing of and actually taking the credit due, as will be described in further detail below. In any of these and still other embodiments, it should be understood that at least some portion of the credit data 615, upon generation thereof, may be provided, whether automatically or upon request therefor, to at least the notification module 700.

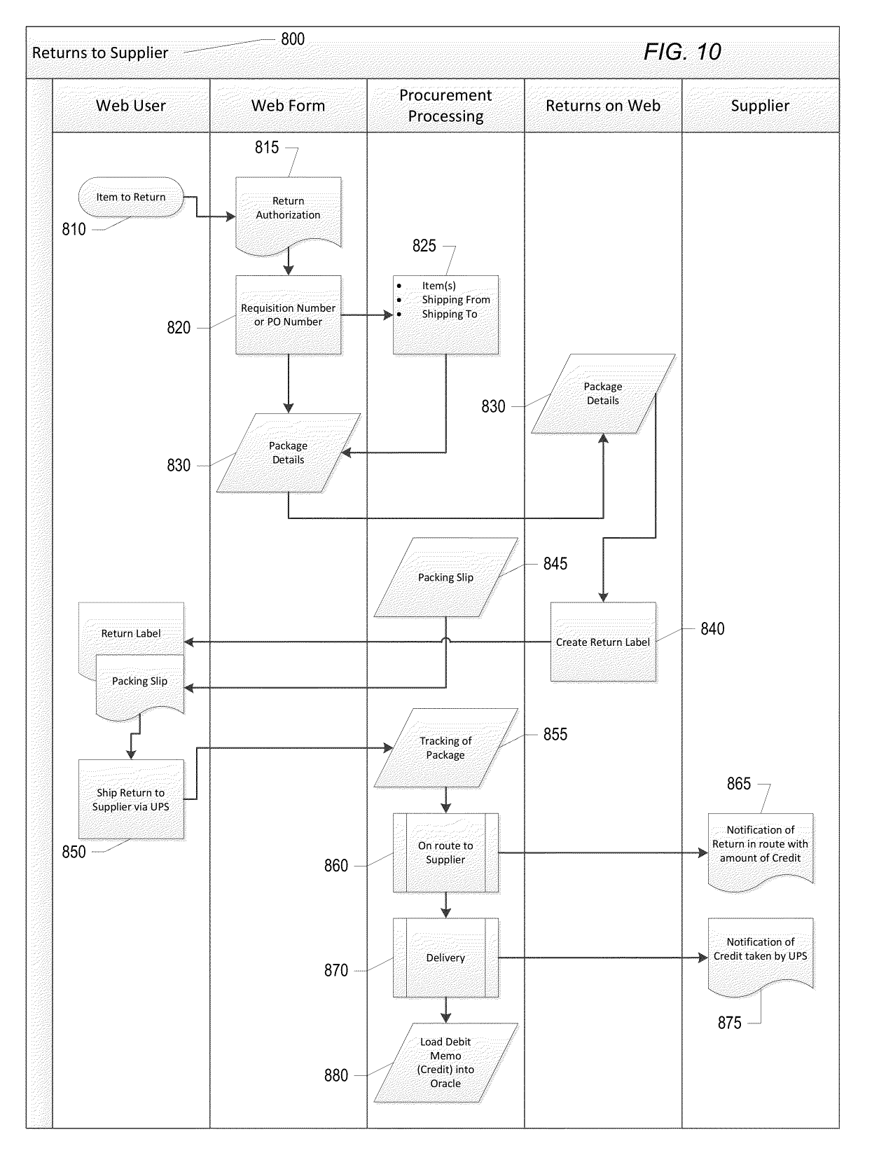

Remaining further with FIG. 5, according to various embodiments, the notification module 700 is configured to activate a notification tool 710 to further process received data. In certain embodiments, the notification module 700 generates one or more reports 712, alerts 714, and/or instructions 716 to one or more users of the system (e.g., carrier, customer, supplier, etc.), however as may be desirable. As a non-limiting example, if the credit data 615 indicates an amount of credit to be taken, an alert or notification may be generated and/or transmitted to at least the supplier. If the credit data 615 indicates that credit should now be taken, not only may an alert be generated and/or transmitted, but also (or alternatively), one or more instruction(s) may be generated so as to facilitate the processing and obtaining of the credit due. In one embodiment, the notification tool 710 of the notification module 700 may be configured to generate and transmit a Debit Memo (credit), which may be applied against one or more outstanding invoices awaiting payment by the carrier or otherwise, all as will be described in further detail below. Notably, however, via the crediting and notification modules 600, 700, the credit due to the carrier is proactively processed by the system without awaiting initiation thereof by the supplier or merchant, as typically necessary with conventional systems and methods. Such may be further understood from at least FIG. 10, which will also be described elsewhere herein. Indeed, all of these features and still further details surrounding the operation and configuration of the various modules 400, 500, 600, and 700 will be described in further detail later herein.

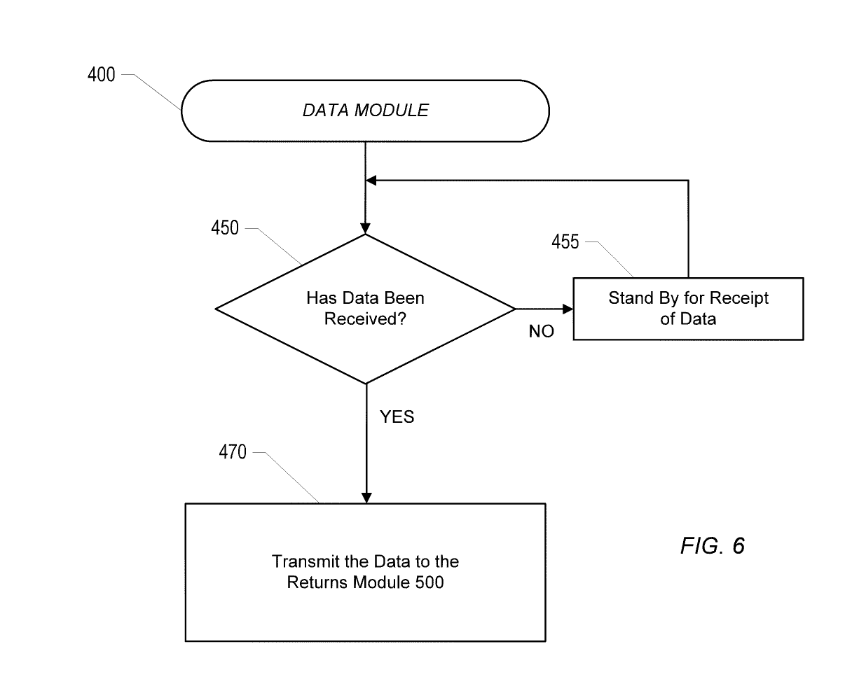

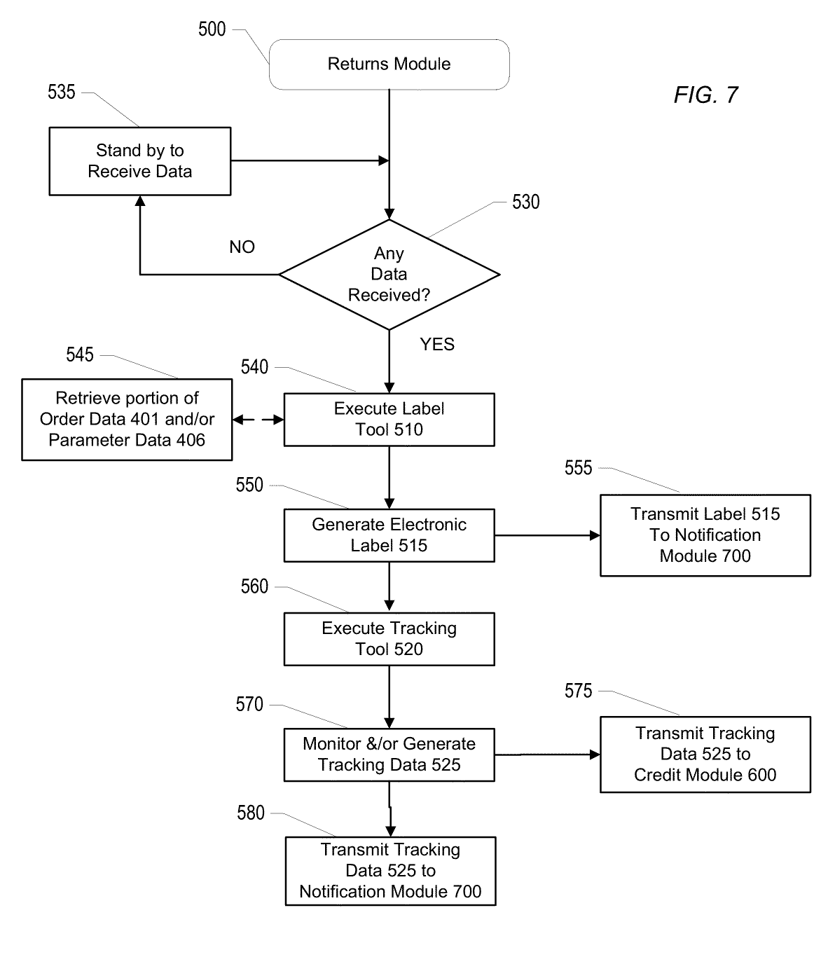

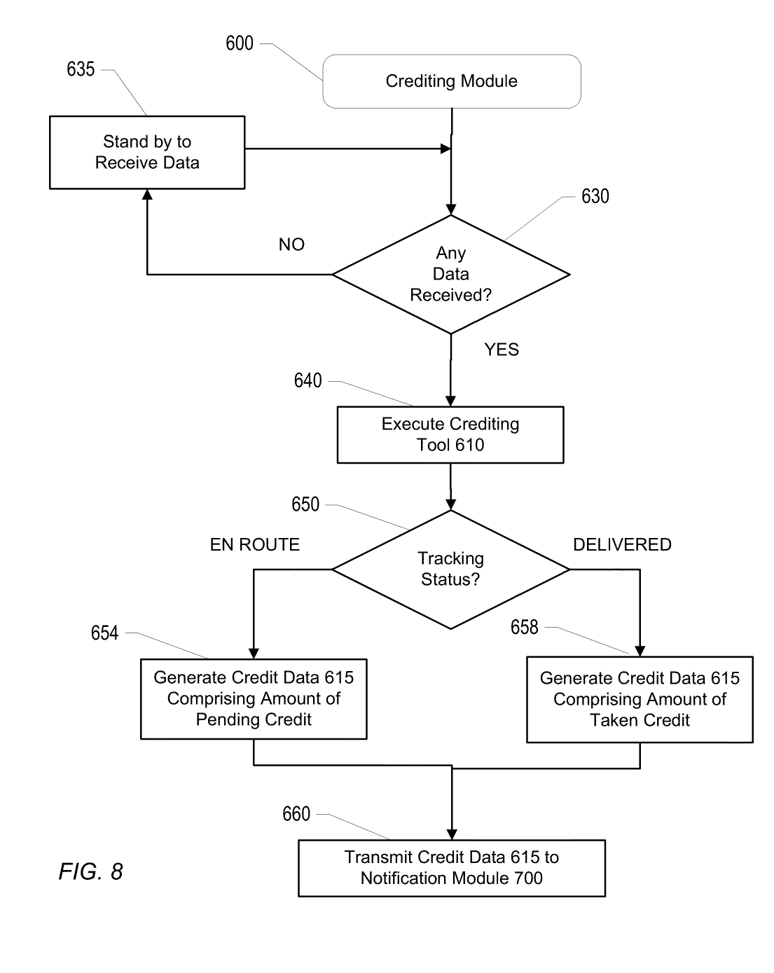

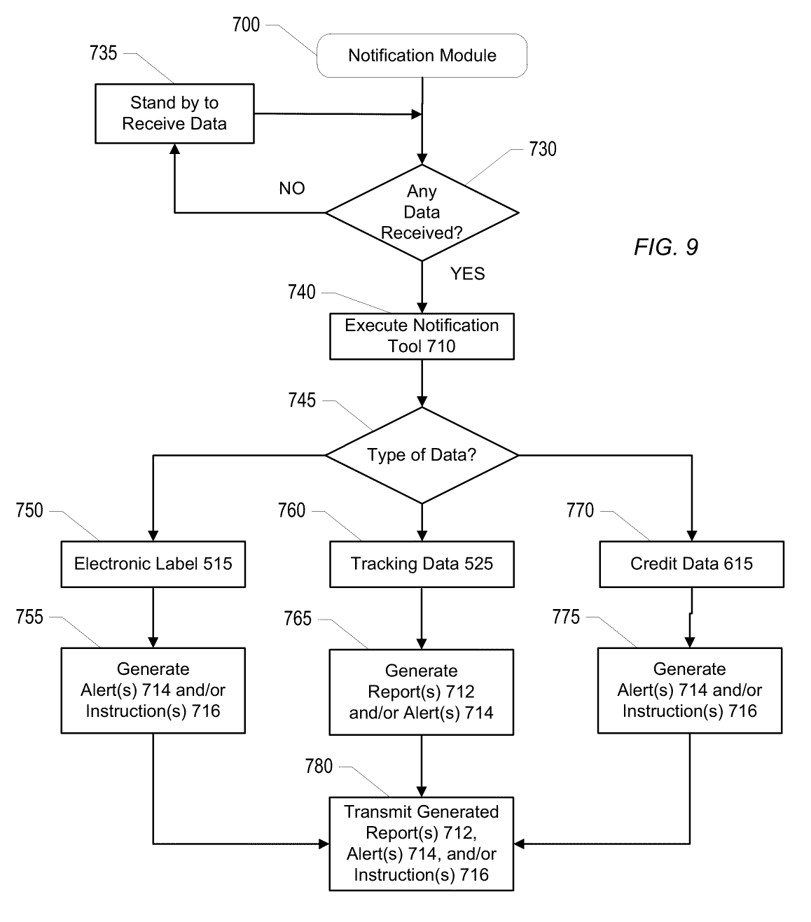

Detailed steps performed by various embodiments of the data module 400 are described in relation to FIG. 6; detailed steps performed by various embodiments of the returns module 500 are described in relation to FIG. 7; detailed steps performed by various embodiments of the crediting module 600 are described in relation to FIG. 8; and detailed steps performed by various embodiments of the notification module 700 are described in relation to FIG. 9. Detailed steps regarding overall operation of the system 20 embodied via the modules, from a more practical perspective is described in relation to FIG. 10. Various screen displays of exemplary provided user interfaces are described in relation to FIGS. 11-16.

With reference now to FIG. 4, it should be understood that the data module 400, according to various embodiments, is configured to at least store and manage any of a variety of types of data. FIG. 4 illustrates a block diagram of various exemplary databases via which the data module 400 manages this information. In particular, in at least the exemplary embodiment shown in FIG. 4, the following databases are provided: an order data database 411, a request data database 412, a label data database 413, a tracking data database 414, a credit data database 415, and a parameter data database 416. Although the embodiment of FIG. 4 shows these databases 411-416 as being separate databases each associated with different types of data, in various other embodiments, some or all of the data may be stored in the same database. In still other embodiments, additional and/or alternative databases may be provided, as may also be desirable for particular applications.

According to various embodiments, the order data database 411 may be configured to store and maintain a variety of order data 401. In certain embodiments, the order data 401 may comprise any of a variety of information related to the order, sale, and/or initial delivery of an item from a supplier or merchant to a customer or purchaser. In this regard, it should be understood that the order data 401 generally comprises data associated with the forward-cycle transaction, as compared to the return-cycle transaction encompassed by the return process itself. That being said, the order data 401 is incorporated and integrated within various embodiments of the system 20 described herein so that any return request data 402 (and processing thereof so as to return a particular item or items) at least so that the return request data may be operatively associated with a purchase order (“PO”) number and/or requisition number that may have been previously assigned to the item(s) during forward-cycle activities.

In these and other embodiments, thus, the order data 401 comprises at least one of a requisition number or a PO number previously associated with one or more items having been previously transported to the customer. Of course, in these and still other embodiments, the order data 401 may comprise additional data regarding the initial transaction, such as the non-limiting examples of item weight, packaging dimensions, customer identification data, and/or tracking identifier data. As will be described elsewhere herein, in at least one embodiment, the tracking identifier within the order data may be likewise incorporated into at least the generated label data 403, whether in conjunction with a newly generated “return” tracking identifier or otherwise. Generally speaking, it should be understood that, upon receipt of any such order data 401, the order data database 401 will store such in a manner associated with at least the data module 400 and is configured to provide the same (whether automatically, manually, and/or at a later time (e.g., upon initiation of a returns request, as may be indicated by receipt of request data 402)) to at least the returns module 500, as will also be described in further detail below. Of course, in any of these and still other embodiments, a variety of alternative configurations could exist, as commonly known and understood in the art.

According to various embodiments, the request data database 412 may be configured to store and maintain any of a variety of request data 402 associated with one or more returns desired by any of a plurality of users of the system (e.g., customers accessing a user interface, as described elsewhere herein). The request data 402 may comprise, in certain embodiments, an identification of at least the item(s) for return, a location the item(s) will be shipping from, and a location the item(s) will be shipping to. The request data 402 in other embodiments may comprise further data elements, such as the non-limiting examples of a requisition number or a PO number, that the user may enter via a query field, so as to retrieve at least a portion of order data 401 previously populated and stored within the system 20 for the particular item(s) for which return is desired.

In still other embodiments, still other types of data elements may be provided within the request data 402, including further non-limiting examples of the day of shipping, the desired day of return delivery, the desired shipment medium, and the like. Generally speaking, it should be understood that, upon receipt of any such request data 402, the request data database 412 will store such in a manner associated with at least the data module 400 and is configured to provide the same (whether automatically, manually, or at a later time) to at least the returns module 500, as will also be described in further detail below. Further details regarding initiation of a return of an item via a network and the return request data associated therewith may be found in at least U.S. Pat. Nos. 7,430,527 & 8,417,574, the contents of both of which are hereby incorporated by reference herein in their entirety. Of course, in any of these and still other embodiments, a variety of alternative configurations could exist, as commonly known and understood in the art.

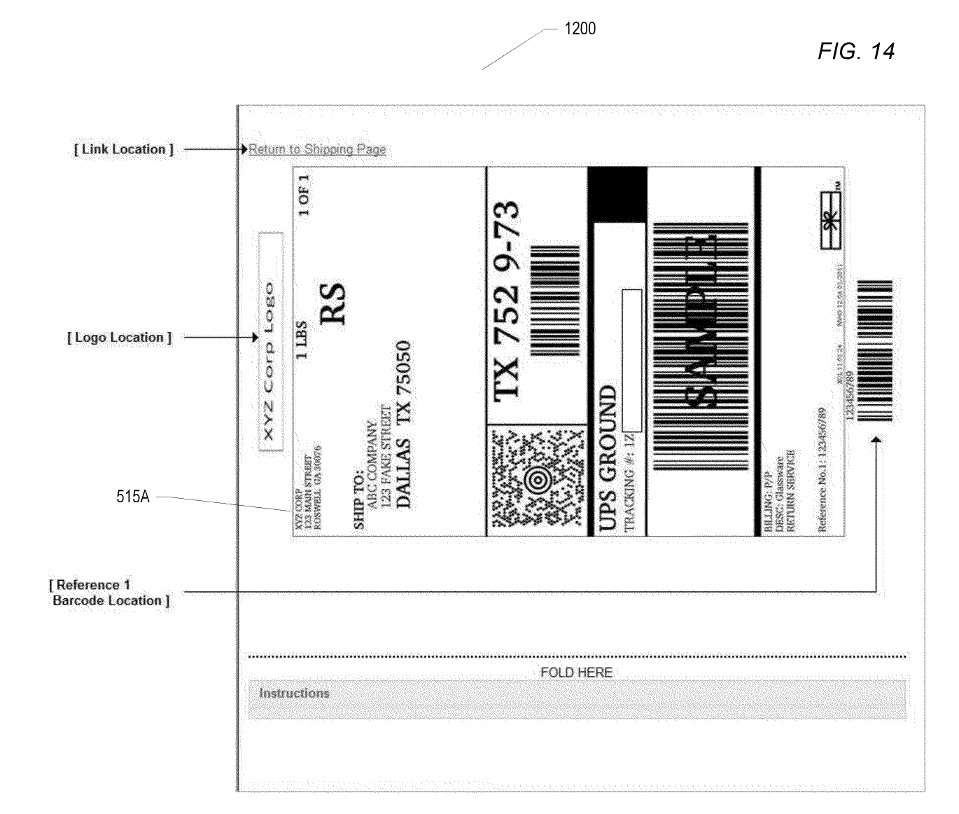

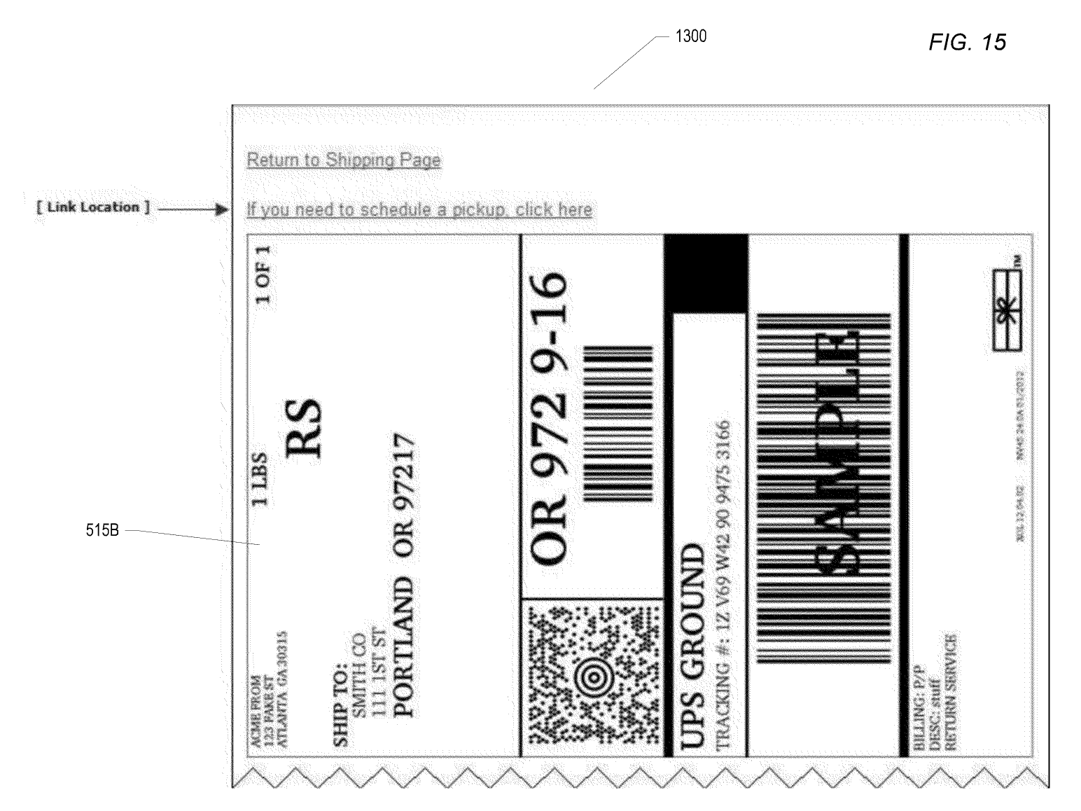

According to various embodiments, the label data database 413 may be configured to store and maintain a variety of label data 403, which may generally include a plurality of pieces of information associated with and/or related to one or more electronic labels, as may be generated by the system 20 described herein. Beyond the data contained on the one or more electronic labels themselves (see FIGS. 14-15 for exemplary electronic label images), it should be understood that in certain embodiments, the label data 403 may further comprise data associated with formatting parameters, whether for the label images themselves, for electronic links (e.g., hyperlinks) thereto, or otherwise. As a non-limiting example, in at least one embodiment, as may be understood with reference to FIG. 14, a label image may be provided to a user via an electronic link, whereby an image thereof may be illustrated for viewing and/or printing, however as may be desirable. Non-limiting examples of data elements within the label data 403 may also comprise a logo field for a customer initiating a return, a package weight field, a shipping from address (as may be retrieved from the request data 402 or otherwise), a shipping to address, one or more barcodes, and/or one or more tracking numbers or identifiers, as such are commonly known and understood in the art (see also FIG. 15, exemplary tracking number 1Z V69 W42 90 9475 3166). Further details regarding electronic label generation and the viewing and/or transmission thereof may be found in at least U.S. Patent Publication 2002/0010689 and U.S. Pat. Nos. 7,430,527 & 8,417,574, the contents of all of which are hereby incorporated by reference herein in their entirety. That being said, in any of these embodiments, upon receipt, the database 413 will store any such received label data 403 in a manner associated with at least the data module 400 and for provision (whether automatically, manually, or at a later time) to at least the returns module 500, as will also be described in further detail below. Of course, in still other embodiments, a variety of alternative configurations could exist, as commonly known and understood in the art.

According to various embodiments, the tracking data database 414 may be configured to receive, store, and maintain tracking data 404 that may comprise any of a variety of information associated with the monitoring and updating of delivery transit data associated with one or more items and/or packages. Such tracking data 404, as such is commonly known and understood in the art, may comprise any of a plurality of data as may be scanned from the item or package (e.g., via a barcode or other indicia located on the item, package, and/or label). Non-limiting examples of tracking data 404 may thus include at least location data, delivery data, en route data, time of scan data, and the like. Further details regarding tracking data, tracking identifiers, and the like may be understood from at least U.S. Patent Publication No. 2006/0265233, the contents of which as are hereby incorporated by reference herein in their entirety. Still further, in any of these and still other embodiments, upon receipt, the tracking data database 414 will store any such received tracking data 404 in a manner associated with at least the data module 400. At least portions thereof, whether in conjunction with tracking data 525 generated by the tracking tool 520 of the returns module 500 (as described elsewhere herein), may also be provided to at least the crediting module 600, as will also be described in further detail below. Of course, in any of these and still other embodiments, a variety of alternative configurations could exist, as commonly known and understood in the art.

According to various embodiments, the credit data database 415 may be configured to receive, store, and maintain credit data 405 that may comprise any of a variety of information associated with one or more return requests, as may have been previously initiated by one or more users of the system. In certain embodiments, the credit data 405 comprises at least a portion of the credit data 615, as may be generated by the crediting tool 610 of the crediting module 600 according to various embodiments. In these and other embodiments, the credit data 405 may include not only credit data 615 associated with a present returns request initiation via the system 20 but prior credit data, whether associated with prior requests by the same user, the same item, the same supplier, or otherwise, however as may be desirable according to certain applications. In at least one embodiment, these and still other types of credit data 405 may be contained within the data module 400 and may be categorized therein, however as may be desirable for certain applications.

As mentioned, the credit data 405 may comprise at least certain portions of the credit data 615, as may be generated by the crediting tool 610, as will be described elsewhere herein. As non-limiting examples, in those and other embodiments, the credit data 405 may thus comprise at least an indication of a credit amount that is considered due to the carrier from the supplier (or entity to which the item(s) is returned). In still other embodiments, the credit data 405 may further comprise at least an indication that the credit amount has been finalized and is thus ready for collection. In yet other embodiments, the credit data 405 may comprise an indication of whether one or more outstanding invoices exist and depending on whether or not such do, further comprise an indication of how the credit amount due should be processed. In such embodiments, the credit data 615 may be referenced by the notification tool 710 of the notification module 700, as described elsewhere herein for purposes of generating one or more instruction(s) 716 to facilitate proactive processing by the system 20 of the credit due from the supplier and to the carrier. Still further, in any of these and still other embodiments, upon receipt, the credit data database 415 will store any such received credit data 405 in a manner associated with at least the data module 400. Of course, in any of these and still other embodiments, a variety of alternative configurations could exist, as commonly known and understood in the art.

According to various embodiments, the parameter data database 416 may be configured to receive, store, and maintain parameter data 406 that may comprise any of a variety of information associated with one or more entities using the system, whether customers, carriers, suppliers, and the like. As a non-limiting example, the parameter data 406 may comprise an indication of whether, upon generation of credit data 405 indicative that a returns shipment is “delivered,” the carrier and/or supplier has approved auto-processing of the credit itself, however as may have been established via a prior agreement between such parties or otherwise. As another non-limiting example, the parameter data 406 may comprise an indication of whether certain types of return initiating requests may be auto-authorized by the supplier or merchant, such as may be desirable, for example, where a high volume of returns for a particular type of item may be anticipated. In other embodiments, the parameter data 406 may comprise an indication of one or more pre-approvals that may be necessary for performance of one or more steps via the system 20, whether with respect to authorization of a return request, transmission of an electronic label link/image, or otherwise. In any of these and still other embodiments, upon receipt, the parameter data database 416 will store any such received parameter data 406 in a manner associated with at least the data module 400 and for provision to at least the returns, crediting, and/or notification modules 500-700 (see FIG. 5), as will also be described in further detail below. Of course, in any of these and still other embodiments, a variety of alternative configurations could exist, as commonly known and understood in the art.

According to various embodiments, any of the previously described databases may be configured to store and maintain not only textually based data, but also graphically based data, as may be generated by the system 20 (or otherwise) and be based, at least in part, upon the textually based data. Still further graphical data (e.g., charts, graphs, maps, etc.) may also be stored within one or more of the databases, wherein such may be, at least in part, independently derived, relative to the textually based data. Non-limiting examples of such graphically based data include trend graphs, historical plot charts, pie charts, maps, diagrams, and the like. It should further be understood that in any of these and still other embodiments, the graphically based data may be used to visually combine various portions of data contained within the various databases previously described herein. Still further, various algorithms and/or pre-determined parameters, rules, and/or mitigating procedures may also be stored within the system 20, as may be desirable for various applications for purposes of performing the various calculations described elsewhere herein.

Summary of Exemplary System Operation

As indicated above, various embodiments of the carrier returns server 200 execute various modules (e.g., modules 400, 500, 600, 700) to provide an integrated tool that facilitates end-to-end management of a return request initiated over a network, including not only handling of the initiating thereof, the provision of an electronic returns label and the tracking of delivery process, but also the timely and efficient processing of credit transactions between carriers and suppliers transporting and receiving the returned item(s). Of course, various alternative configurations to that described herein and as generally illustrated in FIG. 5 may exist without departing from the nature and scope of the various embodiments of the present invention.

Data Module 400

According to various embodiments, as previously mentioned herein, the data module 400 is configured to receive, store, manage, and transmit primarily request data 402, as may be received from one or more users of the system 20 who are seeking to initiate return of an item via a network associated with the system. Within the data module 400 additional data such as the non-limiting examples of order data 401 and parameter data 406 are also received, stored, managed, and/or transmitted, although primarily in supporting fashions relative to the request data 402, the tracking data 404, and/or the credit data 405, all as will be described in further detail below. Receipt may be from any of a variety of entities (e.g., a common carrier, users of the system 20, and the like), however, it is typically a customer user that initially generates the request data 402, and transmission thereof may be to one or more of the modules 500-600, as will be described in further detail below.

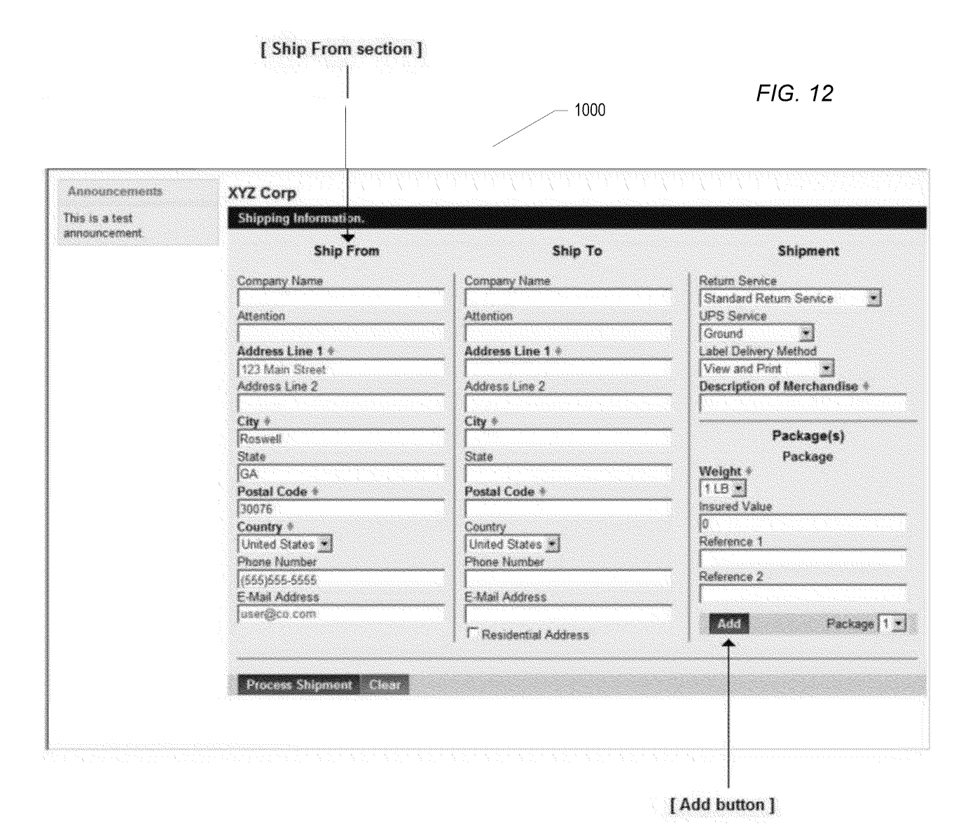

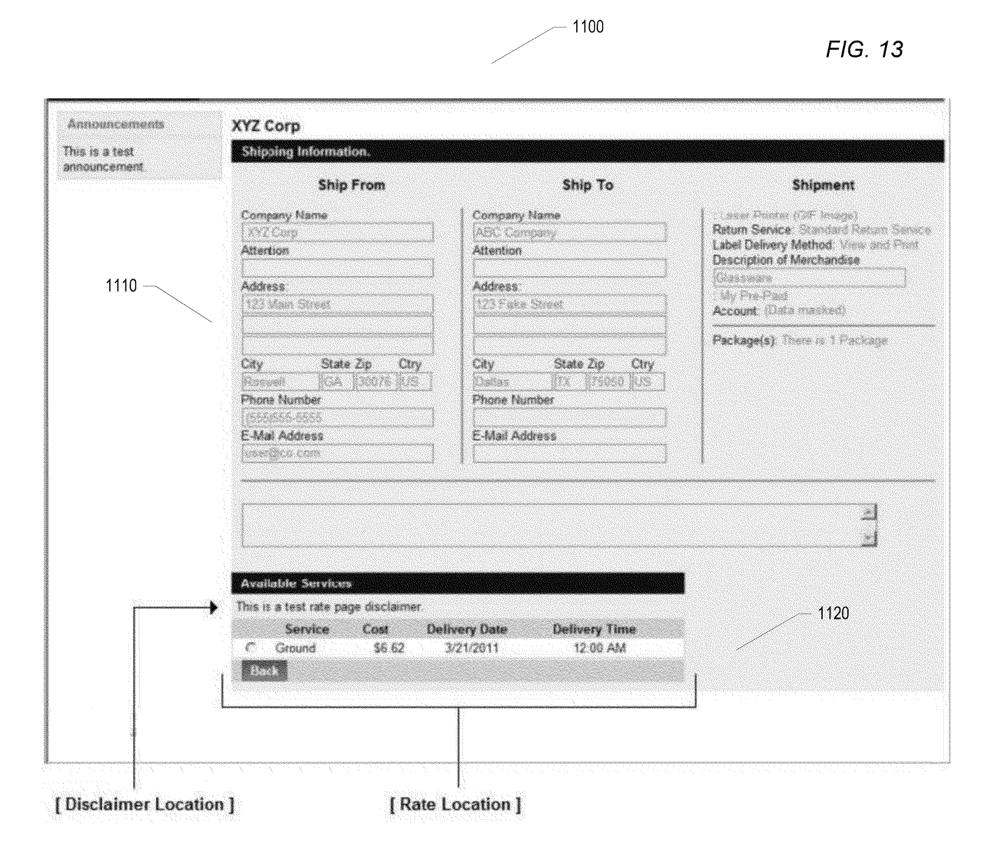

FIG. 6 illustrates steps that may be executed by the data module 400 according to various embodiments. Beginning with step 450, the data module 400 assesses whether any data (e.g., request data 402 in particular, as illustrated in FIG. 5) has been received by the module. In certain embodiments, the data module 400 makes this assessment by periodically scanning one or more databases (see FIG. 4) associated with the module and by identifying some portion of data within one or more of the databases that was not present during a previous periodic scan under step 450. Of course, alternative configurations may be envisioned, wherein, as a non-limiting example, the data module 400 may actively receive at least request data 402 (e.g., as input by a customer or user of the system 20 via an interface (see FIGS. 12-13) and upon receipt thereof, execute step 450. In any of these and still other various embodiments, if “newly received” data is identified, typically in the form of the request data 402, the data module 400 proceeds to step 470; otherwise the module proceeds into a static loop via step 455.

During step 455, the data module 400 may be configured to passively stand by for receipt of new data, whether in the form of request data 402 or otherwise. In certain embodiments, the module 400 may, in step 455, periodically (e.g., every 5 seconds, or at any desirable interval) proactively ping one or more databases contained therein for further update. Of course, various alternative data monitoring configurations may be envisioned, without departing the scope and nature of the present invention.

Remaining with FIG. 6, upon receipt of at least some portion of request data 402, the data module 400 proceeds to step 470, during which the data module transmits the received data to at least the returns module 500 (see FIG. 5) for further handling and processing. In certain embodiments, additional data (e.g., order data 401 and/or parameter data 406) may be simultaneously or later transmitted additionally and/or alternatively to at least the returns module 500. In any of these and still other embodiments, the data module 400 may be configured to automatically perform step 470, while in other embodiments, the module may perform such only periodically, at an interval predetermined by one or more users of the system 20, as may be desirable for particular applications. In still other embodiments, the data module 400 may initially automatically transmit only a portion of the request data 402, whereby such may be associated, via the returns module 500, with corresponding order data 401, via matching of a requisition number or PO number previously associated with the item for which return is desired. In such embodiments, the remainder or at least a portion of the remainder of the request data 402 and/or at least a portion of order data 401 may, upon approval of the request, be further transmitted to the label tool 510 of the returns module 500, particularly in those embodiments wherein authorization for a return request is not configured in a fully automatic fashion, as may be desirable for particular applications or in accordance with one or more portions of the parameter data 406, as also contained within the data module 400. Of course, still further alternative configurations and/or process flows for execution by the data module 400 may be envisioned, without departing from the nature and scope of the various embodiments of the present invention.

Returns Module 500

As previously described, the calculation module 500 is configured to, upon receipt of any portion of at least request data 402 indicative of initiation of a new returns request for a particular item or items by a customer or user of the system 20, at least activate a label tool 510, which is configured to determine whether the returns request should be authorized, and if so, facilitate generation of an electronic label 515 and/or a link thereto containing an image thereof for viewing and/or printing at the customer or user's convenience. In certain embodiments, the returns module 500 is further configured to activate a tracking tool 520 upon at least generation and provision of the electronic label 515 to one or more users of the system, whereby the tracking tool 520 is configured to monitor, receive, and generate real-time, near-real-time, and/or periodic tracking data associated with transit of the item or items (or packages within such are contained) during the returns cycle.

Although described in further detail below with reference to at least FIGS. 7 and 10, it should be understood that further details regarding activities associated with steps generally performed by the returns module 500 described herein (e.g., authorization of return requests, association of return requests with prior purchase order or requisition number data, electronic label generation and/or tracking of returned items during transit) may be understood from at least U.S. Patent Publication Nos. 2002/0010689 & 2006/0265233; and U.S. Pat. Nos. 7,430,527 & 8,417,574, the contents of all of which are hereby incorporated by reference herein in their entirety.

With reference now to FIG. 7, which illustrates various steps that may be executed by the returns module 500, according to various embodiments the module is configured to begin in step 530 by receiving at least some portion of at least request data 402 from the data module 400. In certain embodiments, portions of order data 401 and/or parameter data 406 may also be received, although in other embodiments, such data may be subsequently retrieved by the returns module, as may be necessary (see step 545). It should be understood that in certain embodiments, the returns module 500 may be configured to periodically and/or continuously proactively retrieve and/or check for at least new request data 402, as may be transmitted from the data module 400. In other embodiments, the returns module 500 may merely passively await receipt of data from the data module 400, as may be desirable for particular applications.

With continued reference to FIG. 7, if no data is identified as being received during step 530, the returns module 500 is configured according to various embodiments to proceed to step 535, wherein the module may be configured to passively stand by for receipt of new data, which may be in the form of at least request data 402 as also illustrated in FIGS. 4 and 5 and previously described herein. In certain embodiments, the returns module 500 may, in step 535, periodically (e.g., every 5 seconds, or at any desirable interval) proactively ping one or more databases associated with the data module 400, so as to in a near-real-time fashion sync and thus identify received data efficiently and effectively. Of course, various alternative data monitoring configurations may be envisioned, without departing the scope and nature of the present invention.

Upon receipt of at least some portion of at least request data 402, the returns module 500 proceeds according to various embodiments to step 540, wherein the module is configured to execute a label tool 510. In certain embodiments, the label tool 510 is configured to first retrieve at least a portion of order data 401 and/or parameter data 406 via step 545, which data may be used to assess one or more prerequisites prior to authorization of the return request contained within the request data 402. In at least one embodiment, the request data 402 is associated with corresponding order data 401 associated with a specific requisition number of purchase order (“PO”) number entered by a user of the system during the course of generating the request data 402. Such order data 401 may comprise further information regarding the supplier of the item for which return is requested, in which instance the label tool 510 may be further configured according to certain embodiments to examine at least a portion of the retrieved parameter data 406 so as to determine whether to automatically authorize the request or to proceed otherwise. For example, in one embodiment (not illustrated), the supplier may need to be contacted (e.g., via notification module 700 or otherwise) for a manual approval of a particular request, whether based upon the content thereof or the identity of the requesting user or otherwise.

According to various embodiments, however, it should be understood, that upon authorization of the return request contained within the request data 402, the label tool 510 may proceed further to step 550, as illustrated in FIG. 7, and generate an electronic label 515. In certain embodiments, the electronic label 515 may be embodied as an image as may be viewable and/or printable by a customer or user of the system 20, as such may be seen in at least FIGS. 13 and 14. In other embodiments, the electronic label 515 may be generated as a hyperlink, via which a user of the system 20, namely the user initiating the returns request, may access the electronic label 515, as will be described elsewhere herein.

Returning to FIG. 7, upon execution of step 550, wherein the electronic label 515 is generated, the returns module 500 is configured according to various embodiments to proceed to step 555, wherein the electronic label, or alternatively an image or representation (e.g., a link) thereof is provided to the notification module 700 for further handling thereof, whether for providing to one or more users of the system 20 or otherwise. Further upon execution of step 550, the returns module 500 is configured according to various embodiments to proceed concurrently (or subsequently) to step 560, wherein the tracking tool 520 (see FIG. 5) is executed. The tracking tool 520 of the returns module 500 is configured according to various embodiments to monitor further processing of the returns request (see step 570), and in particular the transit activities associated with the item or package being returned upon placement of the electronic label 515 in a physical form upon either the item or package. Although not described in detail herein, various processes for obtaining the electronic label 515 and for printing and placement thereof upon the item or package may be understood with reference to at least U.S. Patent Publication 2002/0010689, the contents of which is hereby incorporated by reference herein in its entirety.

With reference specifically to step 570, as may be executed by the returns module 500 according to various embodiments, it should be understood that in certain instances the tracking tool 520 may be configured to simply monitor tracking data 404 as may be received by at least the data module 400 from any of a variety of sources. As a non-limiting example, the tracking data 404 may be provided to the system 20 via one or more distributed handheld or mobile devices utilized by the carrier, in particular by a driver of a delivery truck operated by the carrier. In one embodiment, the mobile device may comprise a DIAD device, as previously discussed herein. In these and other embodiments, the tracking tool 520 may be configured to merely monitor the receipt of the tracking data 404, whether on a periodic basis, automatically, and/or otherwise, and upon receipt or identification thereof, simply proceed to steps 575 and/or 580 to transmit the data to one or more of the credit module 500 and the notification module 700.

In still other embodiments, the tracking tool 520 may be configured to generate tracking data 525, which may be based at least in part upon the received tracking data 404 but comprising further parameters and/or data associated therewith. As a non-limiting example, where a particular user of the system has pre-established one or more parameters requesting notification of all tracking data 404 obtained in a certain period (e.g., a day), the tracking tool 520 may generate tracking data 525 comprising at least that data and also an indication of the desired reporting parameter therein, for consolidated transmission to at least the notification module 700. In such embodiments, as will be described in the context of the notification module 700, the user(s) of the system 20 may be provided with periodic reports (e.g., End-of_Day (EOD) reports of status occurring for specific items being returned, as may be desirable, for example, where many items are being anticipated by a supplier or otherwise).

Remaining with FIG. 7 and with further reference to step 570, according to various embodiments, the tracking tool 520 may be configured to generate specific tracking data 525 additionally (or alternatively) to the circumstances described above, upon occurrence of particularly defined tasks. As a non-limiting example, tracking data 525 may be generated (immediately or otherwise) upon receipt of a first indication that the item(s) being returned are now “en route” for return to the supplier. As another non-limiting example, tracking data 525 may be generated (immediately or otherwise) upon receipt of an indication that the item(s) being returned have been actually “delivered” to (e.g., into the hands of) the supplier (or otherwise anticipated receiving party or entity). In such instances, as will be described in further detail below, the tracking tool 520 of the returns module 500 may be configured according to various embodiments to generate an indication thereof in the form of the tracking data 525 and to provide the same to the crediting module 600 via step 575.

In this manner, from a practical perspective, upon occurrence of particular occurrences in the transit of the item(s) being returned (however, as may be pre-defined or pre-established by one or more users of the system 20), the returns module 500 is configured according to various embodiments to transmit generated tracking data 525 or at least an indication thereof to at least the credit module 600 for further handling thereof, as will be described in detail below.

Crediting Module 600

As previously described, the crediting module 600 is configured to, upon receipt of at least a portion of tracking data 525, execute a crediting tool 610, which is configured assess the nature and content of the tracking data 525 so as to determine whether one or more crediting-related actions are necessary at the particular point in time of receipt thereof. If one or more actions are determined necessary, an indication thereof, as a portion of the credit data 615 or otherwise, is transmitted to the notification module 700. Non-limiting examples of actions, as will be described in further detail below, include determination of an anticipated amount of credit to be taken and the facilitation of taking the actual credit due, both as may be triggered at least in part upon the occurrence of one or more particular tracking-related actions, as may be contained (or at least identified) within the tracking data 525.

With reference now to FIG. 8, which illustrates various steps that may be executed by the crediting module 600, according to various embodiments the module is configured to begin in step 630 by receiving at least some portion of tracking data 525 from the returns module 500. It should be understood that in certain embodiments, the crediting module 600 may be configured to periodically and/or continuously proactively retrieve and/or check for at least updated tracking data 525, as may be transmitted from at least one of the returns module 500 or the data module 400. In other embodiments, the crediting module 600 may merely passively await receipt of tracking data 525, regardless of the source thereof, as may be desirable for particular applications.

Remaining with FIG. 8, if no data is identified as being received during step 630, the crediting module 600 is configured according to various embodiments to proceed to step 635, wherein the module may be configured to passively stand by for receipt of new data. In certain embodiments, the crediting module 600 may, in step 635, periodically (e.g., every 5 seconds, or at any desirable interval) proactively ping one or more databases associated with the data module 400, so as to in a near-real-time fashion sync and thus identify received data efficiently and effectively. Of course, various alternative data monitoring configurations may be envisioned, without departing the scope and nature of the present invention.

According to various embodiments and as previously mentioned, data received in step 630 by the crediting module 600 may comprise at least a portion of tracking data 525 and upon receipt thereof, the module may be configured to proceed in step 640 to execute a crediting tool 610. The crediting tool 610 may be configured according to certain embodiments to, as an initial step 650, determine the nature and content of the received tracking data 525 (and/or tracking data 404, as previously discussed). Any of a variety of statuses, as may be determinable from the nature and content of the tracking data 525 may be determined, although two primary and non-limiting examples will be described herein with reference to FIG. 8, particularly whether the item being returned has been placed “en route” and whether the same has been “delivered.” Further processing via the crediting tool 610 upon receipt and determination of such instances are described in further detail below.

In particular, with reference to FIG. 8, if the crediting tool 610 of the crediting module 600 determines in step 650 that the latest received tracking data 525 is indicative of the item(s) being returned having been placed “en route” (e.g., in transit to the supplier anticipating return thereof, as may be indicated by a label scan of the item by an exemplary mobile device such as the DIAD discussed elsewhere herein), the crediting module is configured according to various embodiments to proceed to step 654. During step 654, the crediting tool 610 is configured to generate credit data 615 comprising at least an amount of pending credit that is estimated to be taken upon ultimate delivery of the item(s) being returned.

It should be noted that such credit data 615 indicating a proposed or pending credit is proactively generated in certain embodiments via the crediting module 600 for further transmission thereof to at least one or more suppliers (e.g., via the notification module 700 as described further below). This configuration is in stark contrast with conventional returns processes, whether online or otherwise, which place the onus for handling credits due (or potentially due) to carriers transporting the item(s) being returned on someone other than the carrier (e.g., the supplier). For various reasons, amongst those being a lack of incentives on the part of the supplier to process such credits in a timely and efficient manner, it is advantageous to shift the onus to the carrier, as provided via the crediting module 600 and more generally the system 20 described herein.

In particular, with reference to FIG. 8, if the crediting tool 610 of the crediting module 600 determines in step 650 that the latest received tracking data 525 is indicative of the item(s) being returned having been “delivered” (e.g., receipt confirmed by the supplier or other entity anticipating return thereof, as may be indicated by a label scan of the item by an exemplary mobile device such as the DIAD discussed elsewhere herein), the crediting module is configured according to various embodiments to proceed to step 658. During step 658, the crediting tool 610 is configured to generate credit data 615 comprising at least an amount of credit due that is being collected by the carrier due to an indication within at least the tracking data 525 (or 404) that the item(s) being returned have, in fact, been delivered (i.e., received) by the supplier.

As above, it should be noted that such credit data 615 indicating an actual credit due and pending (or now undergoing) processing is proactively generated in certain embodiments via the crediting module 600 for further transmission thereof to at least one or more suppliers (e.g., via the notification module 700 as described further below). This configuration is in stark contrast with conventional returns processes, whether online or otherwise, which place the onus for handling and in particular processing the settling of credits due (or potentially due) to carriers transporting the item(s) being returned on someone other than the carrier (e.g., the supplier). For various reasons, amongst those being a lack of incentives on the part of the supplier to process such credits in a timely and efficient manner, it is advantageous to shift the onus to the carrier, as provided via the crediting module 600 and more generally the system 20 described herein.

Remaining with FIG. 8, it may be seen, that regardless of whether the crediting tool 610 proceeds to generate credit data 615 via step 654 (for pending credits once “en route”) or via step 658 (for credits fully due upon “delivery”), the crediting module 600 according to various embodiments is configured to proceed, upon generation of such data to step 660. During step 660, the generated credit data 615 may be transmitted in certain embodiments to at least the notification module 700. In other embodiments (see FIG. 5), the credit data 615 may be additionally transmitted to the data module 400 for at least storage and maintenance thereof.

It should be understood with regard to the crediting module 600 in general that any of a variety of tracking statuses beyond that of “en route” or “delivered” may be incorporated as one or more triggers for generation of particular credit data 615 that may be transmitted to the notification module 700 for provision to one or more users of the system.

Notification Module 700

With reference to FIG. 9, according to various embodiments, the notification module 700 is configured to generally receive various types of data from one or more of the data module 400, the returns module 500, and/or the crediting module 600, and to subsequently perform further processing steps based thereon. Beginning with step 730, the notification module 700 may be configured to query whether any items of data (e.g., order data 401, request data 402, parameter data 406, tracking data 525, credit data 615, and/or the like) have been received by the module. If no data has been received, the notification module 700 is configured according to various embodiments to proceed to step 735, wherein the module stands by to receive one or more pieces of data. In certain embodiments, the notification module 700 may simply passively await receipt of data during step 735, while in other embodiments, the notification module 700 may at least periodically (e.g., as pre-determined by one or more users of the system 20) actively query one or more of the modules 400-600 for data, as may be desirable for particular applications. Of course, any of a variety of data calling and/or transmission configurations may be envisioned, without departing from the scope and nature of the present invention.

Although described in further detail below with reference to at least FIG. 10, it should be understood that further details regarding certain activities associated with steps generally performed by the notification module 500 described herein (e.g., notifications regarding tracking status and the generation of one or more alerts in various forms and via various mediums, and the like) may be understood from at least U.S. Patent Publication Nos. 2002/0010689 & 2006/0265233; and U.S. Pat. Nos. 7,430,527 & 8,417,574, the contents of all of which are hereby incorporated by reference herein in their entirety.

Returning to FIG. 9, upon receipt of data in step 730, various embodiments of the notification module 700 are configured to proceed to step 740, during which a notification tool 710 is executed to perform the remaining steps 745-780, as illustrated. With reference to step 745, execution of the notification tool 710 involves according to various embodiments first determining what specific type of data has been received. If at least a portion of the received data includes an electronic label 515 (or an image thereof or link directing a user thereto or the like), the notification module 700 is configured to proceed to steps 750 and 755, as will be described further below. If instead the received data includes tracking data 525 (or tracking data 404) the notification module 700 is configured to proceed to steps 760 and 765, as will be described further below. Lastly, in at least the exemplary embodiment of FIG. 9, if at least a portion of the received data includes credit data 615, whether containing an indication of a pending credit, a credit due, or otherwise, as described previously herein, the notification module 700 is configured to proceed to steps 770 and 775, as will be described further below. Although these three non-limiting examples of steps 750-775 may be seen in at least the illustrated embodiment of FIG. 9, it should be understood that additional and/or alternative configurations may be provided, without departing from the scope and nature of the present invention. That being said, the three non-limiting exemplary sequences of steps, as may be executed by the notification module 700 according to various embodiments are described, in turn, below.

During step 750, upon receipt of at least an electronic label 515 (e.g., from the returns module 500 as previously described herein), the notification tool 710 of the notification module 700 is configured to proceed according to various embodiments to step 755. During step 755, the notification module 700 may be configured in certain embodiments to generate one or more of alerts 714 and/or instructions 716 based at least in part upon the received electronic label 515. As a non-limiting example, upon receipt of the electronic label 515 or an indication thereof in some form or fashion, the notification module may be configured to notify one or more users (e.g., the customer requesting initiation of a return of an item via the system 20) that the label 515 has been generated. In these and other embodiments, the notification module 700 may be further configured to, in step 780 transmit such a notification or alert to the one or more users.

As another non-limiting example, upon receipt of the electronic label 515, the notification tool 710 of the notification module 700 may be configured to additionally and/or alternatively generate one or more instructions 716, which may likewise be transmitted (e.g., via step 780) to one or more users of the system 20, so as to inform them of one or more further steps to take upon receipt of the instructions. For example, the instructions 716 may detail for a customer anticipating receipt of the electronic label 515 to initiate return transit of an item being returned how to print and affix the label to a package containing the item and/or how to determine and select a nearby (or otherwise desirable) pickup location, both as may be seen from FIGS. 13 and 14. In other embodiments, the alerts and/or instructions may be transmitted during step 780 by the notification module 700 to one or more users of the system other than the customer who initiated the return request; for example, a notification, which may itself contain some portion of the label data 403 and/or tracking data 404 described previously herein may be transmitted to at least one of the carrier and/or the supplier, so that either or both may initiate tracking of the item for which return is anticipated. Still other various configurations may be provided, as may be desirable for particular applications.

During step 760, upon receipt of at least tracking data 525 (e.g., from the returns module 500 as previously described herein), the notification tool 710 of the notification module 700 is configured to proceed according to various embodiments to step 765. During step 765, the notification module 700 is configured in certain embodiments to generate one or more of at least one of reports 712 or alerts 714. As a non-limiting example, alerts 714 may be provided to one or more users of the system 20, whether to the customer and/or the supplier and/or otherwise, upon occurrence of various scans or updates associated with transport of the item(s) being returned. Exemplary tracking status updates and the processes for acquiring the same have been previously described herein; however, it should be understood that generation of alerts 714 and/or determination of whether, when, and to whom such should be transmitted (e.g., via step 780) involves the notification tool 710 of the notification module 700 analyzing at least some portion of the parameter data 406, as may be retrieved from at least the data module 400. For example, the supplier may request an alert for when the item is placed “en route” and also an alert for when it is within an hour of delivery. Various alternatives may be envisioned.

In these and still other embodiments, the reports 712 generated via the notification tool 710 of the notification module 710 may be delivered alternatively and/or additionally to the alerts 714 previously described herein. As a non-limiting example, one or more users of the system (e.g., at least the supplier) may request a periodic report of status for one or more items for which return is anticipated. In at least one embodiment, and end-of-day (EOD) report may be generated and transmitted (e.g., via step 780) to at least the supplier. In other embodiments, the EOD and/or analogous and/or still other reports may be provided to any of the supplier, carrier, and/or user or customer requesting initiation of the return, as may be desirable for particular applications. Still other various configurations may be provided, as may be desirable for particular applications.

During step 770, upon receipt of at least credit data 615 (e.g., from the crediting module 600 as previously described herein), the notification module 700 is configured to proceed according to various embodiments to step 775. During step 775, the notification tool 710 of the notification module 700 may be configured to generate one or more alerts 714 and/or instructions 716 based at least in part upon the scope and content of the credit data 615. As a non-limiting example, where the credit data 615 comprises an indication of a pending credit that will be taken by the carrier upon delivery of an item currently “en route” for return, one or more alerts 714 and/or instructions 716 may be generated and transmitted (e.g., via step 780) to at least the supplier anticipating the returned item. In certain embodiments, the alerts and/or instructions 714, 716 may request confirmation (or any various further actions) on the part of the supplier. In other embodiments, the alerts and/or instructions may be provided merely as a courtesy, as a function of the various embodiments of the system 20 described herein shifting the onus for processing such credits from the supplier to the carrier-driven system.

According to various embodiments, in step 775, wherein the credit data 615 comprises, as another non-limiting example, data indicative of the returned item having been delivered (as may be obtained as previously described herein), the notification tool 710 may be configured to particularly generate one or more alerts 714 and/or instructions 716, much as described previously herein. Still further, however, in certain embodiments, upon receipt of such credit data 615 indicative of delivery, the one or more instructions 716 that may be generated may further comprise one or more Debit Memos (Credit) to facilitate application of the credit within the carrier's broader financial transaction framework, whether as an appendage to the system 20 described herein or as a separate system in communication with the system 20 described herein. The instructions 716 may be transmitted to one or more users of the system—whether to parties charged with facilitating settling of the credit due (as described below) and/or to the supplier concurrently with (or subsequently to) the transmitted notification of credit due being taken.

Specifically, the instructions 716 generated may be further tailored according to various embodiments by the notification tool 710 by incorporation of at least a portion of the order data 401 contained within the data module 400. In particular, as previously described herein, the order data 401 may contain a variety of data associated with prior purchase orders and requisition numbers containing the one or more items now being processed by the system 20 for return thereof to one or more suppliers. It should be understood that such order data 401 is configured to contain in certain embodiments one or more invoices generated by the supplier and applied against the carrier relative to the one or more purchase orders and requisition numbers referenced within the order data 401. As such, according to various embodiments, the notification tool 710 according to various embodiments may be configured to determine, prior to generation of particular instructions 716 the nature and content of such instructions. As a non-limiting example, if an outstanding invoice exists against the purchase order or requisition number for which an item has been indicated as returned as “delivered,” the tool 710 may be configured to generate instructions 716 to apply the credit due to that outstanding invoice prior to processing payment thereof. As another non-limiting example, where the pertinent purchase order or requisition number has an invoice applied there-against, but such has either already been paid or is presently being processed for payment, the notification tool 710 may be configured to determine such and upon such determination generate instructions 716 to apply the credit due to a future invoice, whenever such may be received from the particular supplier in question.

According to various embodiments, if no invoices are located by the notification tool 710, whether within the order data 401 of the data module 400 or otherwise, the tool may be configured to, as mentioned previously, to apply the credit due to a future invoice, as may be anticipated to be received from the particular supplier in receipt of the returned item. In these and still other embodiments, whether no invoice exists or whether one existed but was undergoing pre-processing preventing application of the credit thereto, the notification tool 710 may be further configured according to various embodiments to generate one or more alerts 714 and/or instructions 716 configured to initiate collection of the credit via alternative means (e.g., via a collections agency or otherwise). In such instances, the generated alerts 714 and/or instructions 716 may be transmitted not only to one or more users of the system 20 but to external third party entities, such as a contracted collection agency for dealing with such circumstances.

It should be understood that still other various configurations may be provided, as may be desirable for particular applications. As a non-limiting example, at least some portion of the above-described analysis and determination of the scope and content of particular instructions 716 as performed by the notification tool 710 of the notification module 700 may be performed in part or in whole by the crediting tool 610 of the crediting module 600 prior to transmission of any data to the notification module. Details in this regard may vary according to particular desires or needs for particular applications, and as such it should be understood generally that according to various embodiments, the system 20 described herein is configured to generate detailed instructions 716 and/or reports 712 and/or alerts 714, and/or Debit Memos based thereon, which facilitate seamless, timely, and efficient processing and settling of credits due to carriers from suppliers upon delivery confirmation of returned items to the suppliers. Such features, at least in part, provide the advantageous aspects of the various embodiments of the invention described herein, as such advantages and benefits have also been described elsewhere herein.

Exemplary System Operation with Non-Limiting Example

Having thus described an exemplary system 20 and representative modules 400-700 as may be configured according to various embodiments to implement the integrated online returns and credit processing applications provided by the present invention, an exemplary operation of use thereof, as may be undertaken by the one or more users thereof (e.g., returns requesters or customers, carriers, and suppliers) will now be described. Such description will reference, where appropriate tasks as may be conducted by various modules and/or tools previously described, and further reference exemplary user screen interfaces, displays, and generated images (e.g., of electronic labels and instructions or Debit Memos) as necessary. These features will be described, in turn, below, with reference to at least FIGS. 10-16.

With reference now in particular to FIG. 10, a returns to supplier framework/interface 800 is illustrated, as may be provided according to various embodiments of the system 20. As illustrated, although not particularly numbered, the framework 800 may comprise at least a user interface (e.g., web form, exemplary embodiments of which as may be seen in at least FIGS. 12 and 13) and a supplier interface (e.g., via devices 120 and/or devices 300, as previously described herein). In certain embodiments, the system 20 described previously herein may be embodied in at least the illustrated procurement processing interface/server and the returns on the web interface/server of FIG. 10. In these and other embodiments, as will be described in further detail below, various tasks performed by the procurement processing and returns on the web interfaces and/or servers correspond generally to those performed by portions of the various modules 400-700, as have been previously described herein (see FIG. 5).

Returning now to FIG. 10, in step 810 according to various embodiments, a web user (e.g., a customer of the system 20 described previously herein wishing to initiate a return request for one or more items over a network) may identify the one or more items to return. In certain embodiments, identification may be performed via a user (corporate or otherwise) logging into a user interface to initiate a request. An exemplary login portal configuration 900 is illustrated in FIG. 11. In these and other embodiments, the identification of the item(s) to return in step 810 may be based at least in part upon an identification of a purchase order number and/or a requisition number, as may be associated with a prior order for the item to be delivered to the user or customer. Exemplary configurations in this regard have been previously described herein, with reference to the returns module 500 comparing at least a portion of the received request data (e.g., the PO number or requisition number) against corresponding parameters within previously obtained and stored order data (e.g., within the data module 400).

In step 815, according to various embodiments, upon initiation of an indication of the item to return in step 810, the system 20 via the web form may be configured to determine whether the return is authorized. Such determination may be based at least in part upon one or more parameters pre-established by the one or more suppliers to which the item(s) are to be returned.

As illustrated in step 820 and with further reference to FIGS. 12 and 13, the system 20 may be configured according to various embodiments to associate the return request with an existing requisition number or PO number. For example, where customer A wants to return item X to supplier B, the system 20 may be configured in step 820 to first associate a return request for item X with the requisition number or PO number associated with the original provision (e.g., delivery) of item X to the customer. This non-limiting example will be referenced periodically further below, with continued reference to at least FIG. 10.

Turning momentarily to FIGS. 12 and 13, an exemplary customer or user interface for execution of step 825 of FIG. 10, namely population of various item-specific data, is illustrated. As may be seen in FIG. 12 specifically, an exemplary screen display 1000 may be configured to facilitate capture from the customer pertinent data regarding the requested return of the item(s). Non-limiting examples of captured data, as may be received from the customer, may include “ship from” data (e.g., the company name, address, city, state, phone, email, and the like) of the requester of the return; “ship to” data (e.g., the company name, address, city, state, phone, email, and the like) of the recipient of the return (e.g., a supplier); and shipment/package data (e.g., type of service desired, label delivery method options (e.g., view and print or otherwise), a description of the returned item(s), weight of associated packages, reference numbers therefor, and the like). In certain embodiments, at least the “ship from” data, or portions thereof, may be automatically populated based at least in part upon data associated with a user profile stored within the system 20 for the particular user or customer requesting return. In other embodiments, the “ship from” data may not be populated, as may be desirable where the customer or user may wish to identify a nearby (or otherwise convenient) pick-up location for the returned item.

With reference to FIG. 13, it should also be understood that in step 825, upon capture of necessary or desirable “ship from” data, “ship to” data, and/or shipment/package data, an exemplary interface screen 1100 may be configured to present a confirmation portion 1110 indicating to the user the populated data, along with an exemplary service selection portion 1120, wherein the user or customer may select one or more service options, based upon cost, delivery date/time, or other various parameters, as may be desirable and/or illustrated for particular applications. In this manner, it should be understood that the return requester may not only provide shipment data regarding the item and associated package therefor, but also proactively select amongst one or more available service options, as may be provided by the carrier associated with the system 20. In still other embodiments, the user or customer may be further able to select one or more available services from one or more carriers other than the carrier associated with the system.

Returning now to FIG. 10, during step 830, upon population of various data in step 825 (as described above with reference further to FIGS. 12 and 13), the system 20 may be configured according to various embodiments to further obtain package details for the transit of the item to be returned. Such may include package weight, dimensions, and the like, as may be used to generate the one or more available service selections of at least FIG. 13. Such package details within step 830 may be obtained from the customer via the web form (e.g., interface) and provided to at least the returns module 500 of the system. As previously mentioned, but as may be seen in step 825 of FIG. 10, certain portions of the item/shipping data may be obtained from at least the data module 400, wherein data regarding the item and/or shipment details originally from the supplier to the customer may be stored. In this manner, errors and inefficiencies as may be introduced by having a user or customer re-enter such information may be avoided.

Upon compilation of all shipment and package details in steps 825 and 830 of FIG. 10, the system 20 may be configured according to various embodiments to create a return label in step 840. Upon creation thereof, as has been previously described herein, such may be provided to the web user (e.g., via an interface such as the exemplary screen displays 1200 and 1300 of FIGS. 14 and 15. For example, returning to our non-limiting example of customer A requesting return of item X to supplier B—upon obtaining of the pertinent shipping and package data, which may be in this instance to ship from the customer's original receiving location—the system 20 is configured to create and provide to the customer A an appropriately formatted return shipping label, whether via presentation of an image thereof, a link thereto, or otherwise, as previously described herein.

With particular reference to FIG. 14, it should be understood that according to various embodiments, the electronic shipping labels may be customizable based at least in part upon parameters pre-established by either the customer and/or the supplier. In FIG. 14, for example, the electronic label 515A illustrated therein is delivered via a link location and may contain thereon a logo location, wherein a logo of customer A (whose formal name may be XYZ Corp) may be placed. Remaining data elements of the electronic label 515A may be substantially the same to others well known and used in the art, as have been described elsewhere herein. With reference to FIG. 15, by comparison, the electronic label 515B illustrated therein is delivered likewise via a link location, but provides the customer A, for example, the opportunity to schedule a pickup at a nearby or otherwise desirable pickup location. As with FIG. 14, remaining elements of the exemplary electronic label 515B of FIG. 15 are analogous to those commonly known and understood to be located upon shipping labels, as has been described previously herein.

Returning to FIG. 10, upon creation of the return label in step 840 by various embodiments of the system 20 described herein (as embodied as “returns on the web” in the illustration of this figure, such may be, as previously mentioned, provided to the web user or customer via an electronic interface. During step 850, the web user or customer may initiate return shipment to the supplier, which may be from the customer or web user's location, a generated “shipping from” location, or a desirable and selected pickup location, all as previously mentioned. Upon initiation of shipment or transit of the return by customer A via carrier X and to supplier B in step 850, various embodiments further initiate tracking of the package in step 855. In certain embodiments, tracking is initiated upon creation of the label in step 840, with status updates being periodically generated. In such embodiments, the status updates may be configured to indicate one or more statuses indicative of the item or package not yet being “en route.”

FIG. 10 further illustrates generation and provision of a packing slip 845 to a web user, as may be desirable for those embodiments wherein the one or more items being returned are further placed within one or more packages for transit thereof. It should be generally understood that in these and still other embodiments, the packing slip may contain one or more pieces of order data, return request data, shipping data, package data, and/or the like, as packing slips are commonly known to include in the art.

In step 855 according to various embodiments, tracking of the package (or item) may commence. Although illustrated in FIG. 10 as commencing upon shipment of the return from the customer to the supplier in step 850, it may be understood that, as previously mentioned, tracking may commence immediately upon creation of the return label in its electronic form in step 840, as may be desirable for particular applications where pre-“en route” tracking data is desirable. Returning to our non-limiting example, upon pickup of item Y being returned by carrier X from customer A at customer A's house in step 850, the tracking of the package via system 20 in step 855 may commence further to, in step 860, determine that the item is now “on route to supplier.” As illustrated in FIG. 10, upon such determination, as has been described previously herein in the context of the crediting module 600, a notification of the item being returned being in route may be transmitted and/or otherwise provided to the supplier B (e.g., via step 865). The notification may be in any of a variety of formats and via any of a variety of mediums, as previously described herein.

Remaining with step 865 according to various embodiments and as illustrated in FIG. 10, with reference to our non-limiting example involving customer A and supplier B, upon pickup of the item being returned by the carrier X and upon scanning thereof (or some alternative task) to associate an “initiation of transit” indication with the item, package, and/or tracking identifier (e.g., number), the notification of step 865 may be transmitted to the supplier B, thus notifying the supplier that the item is now “en route.” As previously described herein, beyond simply providing a notification of transit status, the notification of step 865 further provides notice to the supplier B that carrier X will be taking a credit in the amount of, for example, $6.62, which may indicate the cost incurred by the carrier for return delivery of the item (see also FIG. 13 delivery cost data). In certain embodiments, the notice of credit amount may be such that the credit amount to be taken is estimated or pending, so as to account for scenarios and/or unforeseen circumstances that may be encountered during the remainder of the return transit process, as such may adversely impact the cost incurred by the carrier X. As a non-limiting example, if the item being returned is temperature sensitive and must be chilled during transport and replenishment of ice or the like mid-transit becomes necessary, the credit amount due to the carrier X may increase relative to the initial estimate provided via step 865.

Turning now to steps 870 and 875 according to various embodiments and as illustrated in FIG. 10, according to various embodiments the system is configured to detect (e.g., via the crediting module 600) when a delivery scan occurs or some other analogous indication is received that the item being returned has now been delivered to supplier B. Upon occurrence thereof, the system 20 is configured in certain embodiments to, in step 875, transmit or otherwise provide to the supplier B a notification that the credit amount due is now being taken by the carrier A. In those embodiments where the initial notification of step 865 contained an estimated credit amount, the notification of step 875 may further contain an indication of whether that estimate has been adjusted since initiation of transit. In these and still other embodiments, the notification may be transmitted to the supplier B via any of a variety of mediums and in any of a variety of formats, as may be desirable and as have been previously described herein. For practical purposes, however, it should be understood generally that the transmission of step 875 to supplier B provides notice to the supplier that the carrier X is commencing reclamation steps for obtaining and settling the credit due via one or more financial transactions.

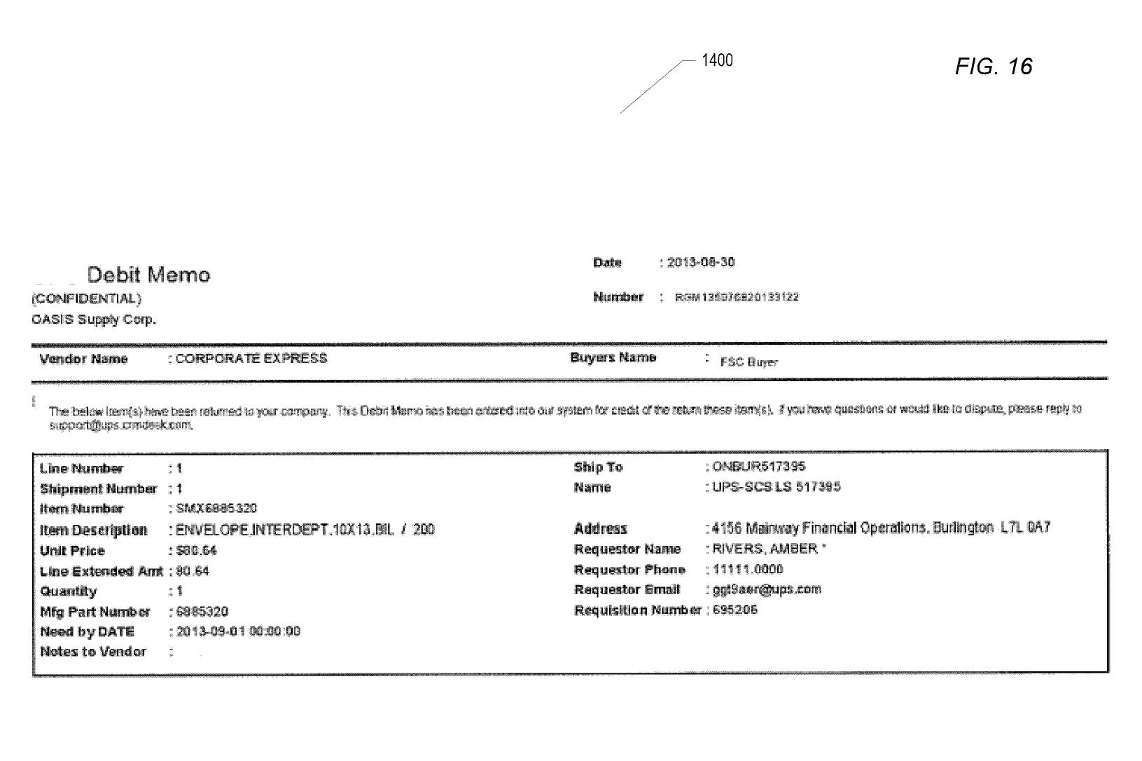

With regard to the process of obtaining and/or settling the credit due to the carrier X, as illustrated in FIG. 10, according to various embodiments, the system 20 may be configured, as previously described herein to generate or load a Debit Memo 1400 (see FIG. 16)) into one or more frameworks or programs (e.g., Oracle) interfaced with the system. In various embodiments, the Debit (Credit) Memo 1400 may also be communicated to the supplier during step 875 or otherwise (e.g., as described previously herein with respect to notification module 700). In certain embodiments, such may involve the system 20 determining whether one or more outstanding invoices exist, as supplier B may have served upon carrier X, for example with respect to initial transport of an item that has now been returned. That being said, any sort of outstanding invoice may be utilized by the system 20 in step 880, whereby the credit amount due to the carrier X for transport of the item(s) being returned to the supplier B is proactively acquired by the system, as operated by the carrier X (or an associated carrier or integrated system/service provider, as may be desirable in certain applications).

With particular reference momentarily to FIG. 16, it should be understood that according to various embodiments the Debit (Credit) Memo 1400 may comprise as at least a portion thereof specific instructions for processing of the credit due to the carrier. Various package and shipment related information may also be provided therein, in various formats, all as may be customizable according to one or more parameters that users of the system 20 described herein may pre-establish. In this regard, the illustrated Memo 1400 of FIG. 16 should be considered as a non-limiting example, provided for purposes of disclosure herein.

Returning to FIG. 10, if no outstanding invoice exists as between supplier B and carrier X in step 880 of FIG. 10, various embodiments of the system 20 may be configured (e.g., via the crediting module 600 and/or the notification module 700 described elsewhere herein) pre-stage the credit due against anticipated future invoices between the pertinent parties. In these and other embodiments, the credit due would thus be proactively (whether automatically or otherwise, for example pending approval by the carrier X or another party) applied against those future invoices, upon receipt thereof. In still other embodiments, invoices undergoing prepayment process that are no longer considered “outstanding” may, in certain circumstances be “pulled from payment” so as to retroactively apply the credit due and re-process.

In yet other embodiments, where no invoice is ever located or identified by the system as between the carrier X and the supplier B, various embodiments of the system 20 may be configured to initiate a collections procedure against the supplier B so as to otherwise obtain and/or settle the amount of credit due. It should be understood that this feature is provided as a feature of various embodiments of the system 20 as recognition of the issues encountered in conventional returns and credit processing systems, wherein credits due to carriers are oftentimes never or in an untimely fashioned generated by the suppliers to the carriers. Various embodiments, as have been described herein seek to alleviate these issues.

As a non-limiting summary, according to various embodiments, a Returns on Web application (e.g., program, module, or the like, as described previously herein) processing may be configured to provide tracking identifiers or numbers for the requests generated and/or authorized for shipments back to suppliers. The tracking numbers may be loaded into an Enhance Return to Supplier Application (ERSA), as may be received via File Transfer Protocol (“FTP”) (or otherwise) in a near-real time or periodic (e.g., daily) fashion. The tracking numbers within ERSA may be further sent to a Tracking Application for association with and provision of latest tracking information during the return process. Communication may be via FTP or any of the variety of communication mediums previously described herein. Tracking information may be returned to ERSA, which may be configured according to various embodiments to process inbound tracking status for each return shipment. In certain embodiments, ERSA notifies the supplier when the item being returned is “en-route,” providing as non-limiting examples details of shipment and the credit that will be taken by the carrier upon completion of the return delivery process. ERSA is also configured according to various embodiments to monitor one or more carrier systems associated with system 20 so as to determine invoice activity from the supplier as it relates to the shipment (or otherwise) to ensure data integrity (e.g., as stored within the data module 400 described previously herein). ERSA is configured in these and other embodiments to continue monitoring tracking and shipment status until delivery occurs, which triggers a notification (e.g., email or otherwise, as described previously herein) to the supplier with an indication that the credit amount due is being taken. In certain embodiments, the notification to the supplier may include a copy of the Debit Memo (indicating credit for taking), which Memo may be further transmitted by ERSA to a carrier financial transaction processing system, which may be configured in conjunction with the system 20 described herein to apply the credit due against an outstanding invoice from the supplier, pre-stage the credit due to be applied against future invoice(s) from the supplier upon receipt thereof, or otherwise.

### CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for facilitating a carrier acquiring a credit amount due for transporting to a supplier one or more items that were previously purchased from the supplier, said method comprising the steps of:
(A) receiving and storing within one or more memory storage areas request data associated with at least one return request initiated by at least one customer for the transport of the one or more items being returned to the supplier;
(B) assigning, via one or more computer processors, a tracking identifier to the at least one return request, the tracking identifier being configured for tracking shipment of the one or more items during transport to the supplier;
(C) generating, via the one or more computer processors, an electronic shipping label, the electronic shipping label comprising a representation of at least the tracking identifier and being configured for use by at least one carrier to facilitate transport of the one or more items to the supplier;
(D) receiving tracking data associated with transport of the one or more items being returned to the supplier, the tracking data being associated with the tracking identifier assigned to the at least one return request;
(E) determining, via the one or more computer processors, a transit status for the one or more items, the transit status being determined based at least in part upon the received tracking data; and
(F) in response to the transit status indicating delivery of the one or more items to the supplier is completed, generating, via the one or more computer processors, one or more notifications of a credit amount due the carrier, the one or more notifications being configured to facilitate the carrier obtaining the credit amount due from the supplier.

2. The computer-implemented method of claim 1, further comprising the step of, in response to the transit status indicating transit of the one or more items to the supplier has commenced, generating, via the one or more computer processors, one or more notifications of a pending credit amount to be taken by the carrier upon delivery of the one or more items to the supplier.

3. The computer-implemented method of claim 2, wherein:
the one or more notifications of the pending credit amount comprise at least one electronic alert; and
the method further comprises the step of transmitting, via the one or more computer processors, the at least one electronic alert to at least the supplier.

4. The computer-implemented method of claim 1, wherein:
the one or more notifications of the credit amount due comprise at least one electronic alert; and
the method further comprises the step of transmitting, via the one or more computer processors, the at least one electronic alert to at least the supplier.

5. The computer-implemented method of claim 1, wherein:
the one or more notifications of the credit amount due comprise at least one instruction to initiate processing of the credit amount due; and
the method further comprises the steps of:
retrieving from the one or more memory storage areas order data, the order data comprising at least one or more supplier invoices associated with the one or more items being returned to the supplier; and
determining, via the one or more computer processors, whether at least one of the one or more supplier invoices remains outstanding.

6. The computer-implemented method of claim 5, wherein the at least one instruction comprises at least one Debit Memo, the Debit Memo being configured to apply the credit amount due against at least one outstanding supplier invoice.

7. The computer-implemented method of claim 5, further comprising the step of, in response to identifying at least one outstanding supplier invoice, applying, via the one or more computer processors, the at least one instruction against the at least one outstanding supplier invoice to facilitate the carrier obtaining the credit amount due.

8. The computer-implemented method of claim 7, wherein application of the at least one instruction against the at least one outstanding supplier invoice results in a reduction in the amount payable via the invoice to the supplier by the carrier.

9. The computer-implemented method of claim 5, further comprising the step of, in response to not identifying at least one outstanding supplier invoice, pre-staging, via the one or more computer processors, the at least one instruction against the supplier's account.

10. The computer-implemented method of claim 9, wherein, upon receipt and identification of at least one outstanding supplier invoice, the method further comprises the step of applying, via the one or more computer processors, the at least one instruction against the at least one outstanding supplier invoice to facilitate the carrier obtaining the credit amount due.

11. The computer-implemented method of claim 9, wherein upon passage of a predetermined period of time, the method further comprises the step of transmitting, via the one or more computer processors, the at least one instruction to at least one entity other than the supplier, the at least one entity other than the supplier being configured to initiate a collection process against the supplier.

12. The computer-implemented method of claim 1, wherein, prior to the step of assigning the tracking identifier to the at least one return request, the method further comprises the step of determining, via the one or more computer processors, whether the at least one return request should be authorized for return transit to the supplier, the determination step being based at least in part upon one or more parameters established by at least the supplier.

13. The computer-implemented method of claim 1, further comprising the steps of:
transmitting, via the one or more computer processors, the electronic shipping label to at least the at least one customer initiating the return request; and
in response to receiving a communication that the electronic shipping label has been printed, activating the tracking identifier assigned to the at least one return request.

14. The computer-implemented method of claim 1, further comprising the steps of:
generating, via the one or more computer processors, one or more periodic reports, the reports comprising at least tracking data associated with the at least one return request; and
transmitting the one or more periodic reports to at least one of the customer or the supplier.

15. The computer-implemented method of claim 14, wherein the one or more periodic reports comprise at least one End-of-Day (EOD) report.

16. An online returns management system for facilitating a carrier acquiring a credit amount due for transporting to a supplier one or more items that were previously purchased from the supplier, said system comprising:
one or more memory storage areas containing existing order data associated with the one or more items; and
one or more computer processors configured to:
(A) receive request data associated with at least one return request initiated by at least one customer for the transport of the one or more items being returned to the supplier;
(B) assign a tracking identifier to the at least one return request, the tracking identifier being associated further with the existing order data and being configured for tracking shipment of the one or more items during transport to the supplier;
(C) generate an electronic shipping label, the electronic shipping label comprising a representation of at least the tracking identifier and being configured for use by at least one carrier to facilitate transport of the one or more items to the supplier;
(D) receive tracking data associated with transport of the one or more items being returned to the supplier, the tracking data being associated with the tracking identifier assigned to the at least one return request;
(E) determine a transit status for the one or more items, the transit status being determined based at least in part upon the received tracking data; and
(F) in response to the transit status indicating delivery of the one or more items to the supplier is completed, generate one or more notifications of a credit amount due the carrier, the one or more notifications being configured to facilitate the carrier obtaining the credit amount due from the supplier.

17. The online returns management system of claim 16, wherein the one or more computer processors are further configured to, in response to the transit status indicating transit of the one or more items to the supplier has commenced, generate one or more notifications of a pending credit amount to be taken by the carrier upon delivery of the one or more items to the supplier.

18. The online returns management system of claim 17, wherein:
the one or more notifications of the pending credit amount comprise at least one electronic alert; and
the one or more computer processors are further configured to transmit the at least one electronic alert to at least the supplier.

19. The online returns management system of claim 16, wherein:
the one or more notifications of the credit amount due comprise at least one electronic alert; and
the one or more computer processors are further configured to transmit the at least one electronic alert to at least the supplier.

20. The online returns management system of claim 16, wherein:
the one or more notifications of the credit amount due comprise at least one instruction to initiate processing of the credit amount due; and
the one or more computer processors are further configured to:
retrieve from the one or more memory storage areas order data, the order data comprising at least one or more supplier invoices associated with the one or more items being returned to the supplier; and
determine whether at least one of the one or more supplier invoices remains outstanding.

21. The online returns management system of claim 20, wherein the at least one instruction comprises at least one Debit Memo, the Debit Memo being configured to apply the credit amount due against at least one outstanding supplier invoice.

22. The computer-implemented method of claim 20, wherein the one or more computer processors are further configured to, in response to identifying at least one outstanding supplier invoice, apply the at least one instruction against the at least one outstanding supplier invoice to facilitate the carrier obtaining the credit amount due.

23. The online returns management system of claim 22, wherein application of the at least one instruction against the at least one outstanding supplier invoice results in a reduction in the amount payable via the invoice to the supplier by the carrier.

24. The online returns management system of claim 20, wherein the one or more computer processors are further configured to, in response to not identifying at least one outstanding supplier invoice, pre-stage the at least one instruction against the supplier's account.

25. The online returns management system of claim 24, wherein, upon receipt and identification of at least one outstanding supplier invoice, the one or more computer processors are further configured to apply the at least one instruction against the at least one outstanding supplier invoice to facilitate the carrier obtaining the credit amount due.

26. A non-transitory computer program product comprising at least one computer-readable storage medium having computer-readable program code portions embodied therein, the computer-readable program code portions comprising:
an executable portion configured for assigning a tracking identifier to the at least one return request, the tracking identifier being configured for tracking shipment of the one or more items during transport to the supplier;
an executable portion configured for receiving a plurality of data, wherein said data comprises:
(i) existing order data associated with the one or more items;
(ii) request data associated with at least one return request initiated by at least one customer for the transport of the one or more items being returned to the supplier; and
(iii) tracking data associated with transport of the one or more items being returned to the supplier, the tracking data being associated with the tracking identifier assigned to the at least one return request;
an executable portion configured for generating an electronic shipping label, the electronic shipping label comprising a representation of at least the tracking identifier and being configured for use by at least one carrier to facilitate transport of the one or more items to the supplier; and
an executable portion configured for:
determining a transit status for the one or more items, the transit status being determined based at least in part upon the received tracking data; and
in response to the transit status indicating delivery of the one or more items to the supplier is completed, generating one or more notifications of a credit amount due the carrier, the one or more notifications being configured to facilitate the carrier obtaining the credit amount due from the supplier.

27. The non-transitory computer program product of claim 26, wherein at least one of the executable portions is further configured for generating one or more notifications of a pending credit amount to be taken by the carrier upon delivery of the one or more items to the supplier.

28. The non-transitory computer program product of claim 26, wherein:
the one or more notifications of the credit amount due comprise at least one instruction to initiate processing of the credit amount due; and
at least one of the executable portions is further configured for:
retrieving from the one or more memory storage areas at least a portion of the order data, the retrieved order data comprising at least one or more supplier invoices associated with the one or more items being returned to the supplier; and
determining whether at least one of the one or more supplier invoices remains outstanding.

29. The non-transitory computer program product of claim 28, wherein, at least one of the executable portions is further configured for, in response to identifying at least one outstanding supplier invoice, applying the at least one instruction against the at least one outstanding supplier invoice to facilitate the carrier obtaining the credit amount due.

30. The non-transitory computer program product of claim 28, wherein, at least one of the executable portions is further configured for, in response to not identifying at least one outstanding supplier invoice, pre-staging the at least one instruction against the supplier's account.
